(19) United States
(12) Patent Application Publication
(10) Pub. No.: US 2020/0123680 A1
(43) Pub. Date: Apr. 23, 2020

(54) Use of Microfibers and/or Nanofibers in Apparel and Footwear

(71) Applicants: Simon Padron, Edinburg, TX (US); Thomas D. Carr, Franklin, TN (US); Kial Gramley, San Juan, TX (US); Stephen R. Kay, Austin, TX (US)

(72) Inventors: Simon Padron, Edinburg, TX (US); Thomas D. Carr, Franklin, TN (US); Kial Gramley, San Juan, TX (US); Stephen R. Kay, Austin, TX (US)

(73) Assignee: CLARCOR Inc., Franklin, TN (US)

(21) Appl. No.: 16/066,947

(22) PCT Filed: Jan. 5, 2017
(86) PCT No.: PCT/US2017/012295

§ 371 Date: Jun. 28, 2018

Related U.S. Application Data
(60) Provisional application No. 62/276,498, filed on Jan. 8, 2016.

(51) Int. Cl. D01D 5/00; A43B 1/14; D01D 5/18; D01F 13/04; B29C 41/00; B29C 41/08; B29D 35/12

(52) U.S. Cl. CPC D01D 5/0084; A43B 1/14; D01D 5/18; D01F 13/04; B29C 41/003; B29K 2105/124; B29C 41/085; B29D 35/126; D10B 2501/043; D10B 2501/041; D10B 2501/042; B29C 41/006

(57) ABSTRACT

Described herein are apparatuses and methods of creating fibers, such as microfibers and nanofibers for the production of clothing items and footwear. Also described herein is a microfiber and/or nanofiber coating system having a support that holds an object to be coated by fibers during the coating process. The support may move the object with respect to the fibers, such that at least a portion of each of the exterior surfaces of the object are coated by the fibers formed by the microfiber and/or nanofiber coating system.

### FIELD OF THE INVENTION

This invention generally relates to the field of fiber production. More specifically, the invention relates to the use of fibers of micron and sub-micron size diameters in apparel and footwear.

### BRIEF SUMMARY OF THE INVENTION

Fibers having small diameters (e.g., micrometer (“micron”) to nanometer (“nano”)) are useful in a variety of fields from the clothing industry to military applications. For example, in the biomedical field, there is a strong interest in developing structures based on nanofibers that provide scaffolding for tissue growth to effectively support living cells. In the textile field, there is a strong interest in nanofibers because the nanofibers have a high surface area per unit mass that provide light, but highly wear resistant, garments. As a class, carbon nanofibers are being used, for example, in reinforced composites, in heat management, and in reinforcement of elastomers. Many potential applications for small-diameter fibers are being developed as the ability to manufacture and control their chemical and physical properties improves.

It is well known in fiber manufacturing to produce extremely fine fibrous materials of organic fibers, such as described in U.S. Pat. Nos. 4,043,331 and 4,044,404, where a fibrillar mat product is prepared by electrostatically spinning an organic material and subsequently collecting spun fibers on a suitable surface; U.S. Pat. No. 4,266,918, where a controlled pressure is applied to a molten polymer which is emitted through an opening of an energy charged plate; and U.S. Pat. No. 4,323,525, where a water soluble polymer is fed by a series of spaced syringes into an electric field including an energy charged metal mandrel having an aluminum foil wrapper there around which may be coated with a PTFE (Teflon™) release agent. Attention is further directed to U.S. Pat. Nos. 4,044,404, 4,639,390, 4,657,743, 4,842,505, 5,522,879, 6,106,913 and 6,111,590—all of which feature polymer nanofiber production arrangements.

Electrospinning is a major manufacturing method to make nanofibers. Examples of methods and machinery used for electrospinning can be found, for example, in the following U.S. Pat. Nos. 6,616,435; 6,713,011; 7,083,854; and 7,134,857.

### BRIEF DESCRIPTION OF THE DRAWINGS

Advantages of the present invention will become apparent to those skilled in the art with the benefit of the following detailed description of embodiments and upon reference to the accompanying drawings, in which:

FIG. 1A depicts an embodiment of a body of a fiber producing device with four external draft members;

FIG. 1B depicts a cross-section of an embodiment of a body of a fiber producing device with four external draft members;

FIG. 2 depicts an alternate version of a gear fiber producing device;

FIG. 3A depicts a fiber producing device having a diameter that varies between a top surface and a bottom surface of the body and includes multiple rows of orifices;

FIG. 3B depicts a close-up or a portion of the body denoted by the box in FIG. 3A;

FIG. 4A depicts a fiber producing device having a rounded profile having multiple rows of orifices;

FIG. 4B depicts a close-up or a portion of the body denoted by the box in FIG. 4A;

FIG. 5A depicts a fiber producing device having an asymmetric profile;

FIG. 5B depicts a close-up or a portion of the body denoted by the box in FIG. 5A;

FIG. 6A depicts an embodiment of a fiber producing system with a driver mounted above the fiber producing device;

FIG. 6B depicts an embodiment of a cross section of a fiber producing system with a driver mounted above the fiber producing device;

FIG. 6C depicts an embodiment of a cross section of a body of a fiber producing system;

FIG. 6D depicts an embodiment of a cross section of a body of a portion of a sidewall, top member, and bottom member of a fiber producing system;

FIG. 7 depicts an alternate embodiment of a fiber producing device;

FIG. 8 depicts an exploded view of the fiber producing device of FIG. 7;

FIG. 9 depicts a fiber deposition system;

FIG. 10 depicts a schematic diagram of a fiber deposition system in use;

FIG. 11 depicts an embodiment of a microfiber and/or nanofiber coating system coating an object with fibers;

FIG. 12 depicts an embodiment of a microfiber and/or nanofiber coating system coating an object with fibers while the object is being held by a support;

FIG. 13 depicts an embodiment of a support for holding an object being coated by fibers produced by a microfiber and/or nanofiber coating system;

FIGS. 14-16 depicts an embodiment of support for a microfiber and/or nanofiber coating system with the support holding an object in an exemplary position;

FIGS. 17-19 depicts an embodiment of support for a microfiber and/or nanofiber coating system with the support holding an object in an exemplary position;

FIG. 20 depicts an embodiment of a microfiber and/or coating system with a support holding an object while the object is being coated by fibers produced by the microfiber and/or nanofiber coating system;

FIG. 21 depicts an embodiment of a support in a first position holding an object to be coated by a microfiber and/or nanofiber coating system;

FIG. 22 depicts the support of FIG. 22 in a second position holding an object to be coated by a microfiber and/or nanofiber coating system;

FIG. 23 depicts an embodiment of a support in a first position holding an object to be coated by a microfiber and/or nanofiber coating system;

FIG. 24 depicts the support of FIG. 23 in a second position holding an object to be coated by a microfiber and/or nanofiber coating system;

FIG. 25 depicts an embodiment of a support in a first position holding an object to be coated by a microfiber and/or nanofiber coating system;

FIG. 26 depicts the support of FIG. 25 in a second position holding an object to be coated by a microfiber and/or nanofiber coating system;

FIG. 27 depicts an embodiment of a support in a first position holding an object to be coated by a microfiber and/or nanofiber coating system;

FIG. 28 depicts the support of FIG. 27 in a second position holding an object to be coated by a microfiber and/or nanofiber coating system;

FIG. 29 depicts a first or starting position in a series of movements of an embodiment of a support that may be used to substantially fully coat an object;

FIG. 30 depicts a second position in a series of movements of an embodiment of a support that may be used to substantially fully coat an object;

FIG. 31 depicts a third position in a series of movements of an embodiment of a support that may be used to substantially fully coat an object;

FIG. 32 depicts a fourth position in a series of movements of an embodiment of a support that may be used to substantially fully coat an object;

FIG. 33 depicts a fifth position in a series of movements of a support that may be used to substantially fully coat an object;

FIG. 34 depicts a sixth position in a series of movements of an embodiment of a support that may be used to substantially fully coat an object;

FIG. 35 depicts a seventh position in a series of movements of a support that may be used to substantially fully coat an object;

FIG. 36 depicts an eight position in a series of movements of an embodiment of a support that may be used to substantially fully coat an object;

FIG. 37 depicts a ninth position in a series of movements of an embodiment of a support that may be used to substantially fully coat an object;

FIG. 38 depicts an alternative embodiment of a support holding an object to be coated by a microfiber and/or nanofiber coating system.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE INVENTION

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural references unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a method or apparatus that “comprises,” “has,” “includes” or “contains” one or more steps or elements possesses those one or more steps or elements, but is not limited to possessing only those one or more steps or elements. Likewise, an element of an apparatus that “comprises,” “has,” “includes” or “contains” one or more features possesses those one or more features, but is not limited to possessing only those one or more features.

Described herein are apparatuses and methods of creating fibers, such as microfibers and nanofibers. The methods discussed herein employ centrifugal forces to transform material into fibers. Apparatuses that may be used to create fibers are also described. Some details regarding creating fibers using centrifugal forces may be found in the following U.S. Patent Application Publication Nos: 2009/0280325 entitled “Methods and Apparatuses for Making Superfine Fibers” to Lozano et al.; 2009/0280207 entitled “Superfine Fiber Creating Spinneret and Uses Thereof” to Lozano et al.; 2014/0042651 entitled “Systems and Methods of Heating a Fiber Producing Device” to Kay et al.; 2014/0159262 entitled “Devices and Methods for the Production of Microfibers and Nanofibers in a Controlled Environment” to Kay et al. 2014/0035179 entitled “Devices and Methods for the Production of Microfibers and Nanofibers” and U.S. Pat. No. 8,721,319 entitled “Superfine Fiber Creating Spinneret and Uses Thereof to Lozano et al.; U.S. Pat. No. 8,231,378 entitled “Superfine Fiber Creating Spinneret and Uses Thereof to Lozano et al.; U.S. Pat. No. 8,647,540 entitled “Apparatuses Having Outlet Elements and Methods for the Production of Microfibers and Nanofibers” to Peno; U.S. Pat. No. 8,777,599 entitled “Multilayer Apparatuses and Methods for the Production of Microfibers and Nanofibers” to Peno et al.; U.S. Pat. No. 8,658,067 entitled “Apparatuses and Methods for the Deposition of Microfibers and Nanofibers on a Substrate” to Peno et al.; U.S. Pat. No. 8,647,541 entitled “Apparatuses and Methods for Simultaneous Production of Microfibers and Nanofibers” to Peno et al.; U.S. Pat. No. 8,778,240 entitled “Split Fiber Producing Devices and Methods for the Production of Microfibers and Nanofibers” to Peno et al.; and U.S. Pat. No. 8,709,309 entitled “Devices and Methods for the Production of Coaxial Microfibers and Nanofibers” to Peno et al.; all of which are incorporated herein by reference.

In some embodiments, a fiber producing device may include a body. The body may be formed such that a portion of the body may function to facilitate conveyance of produced fibers away from the body. For example, the body of a fiber producing device may include draft members which create a gas flow proximate to the fiber producing device. In some embodiments, a fiber producing device may include two or more draft members. In some embodiments, a fiber producing device may include four draft members. Draft members may function as blades on a fan creating a gas current. The gas current created by the draft members may facilitate movement of the produced fibers away from the fiber producing device. The gas currents may direct the produced fibers in a fiber producing system. In some embodiments, draft members may be angled out of the plane of the body of the fiber producing device. Draft members may be angled, much like blades of a fan, increasing the strength of a gas current produced by the draft members. In some embodiments, an angle of the draft members may be adjusted by a user in order to increase/decrease a strength of the gas current produced during use. Upon adjustment the draft members may be locked into place.

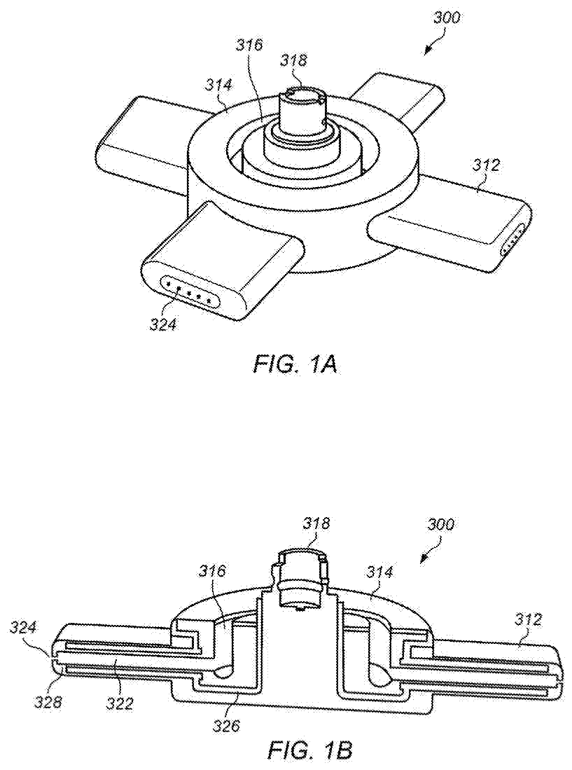

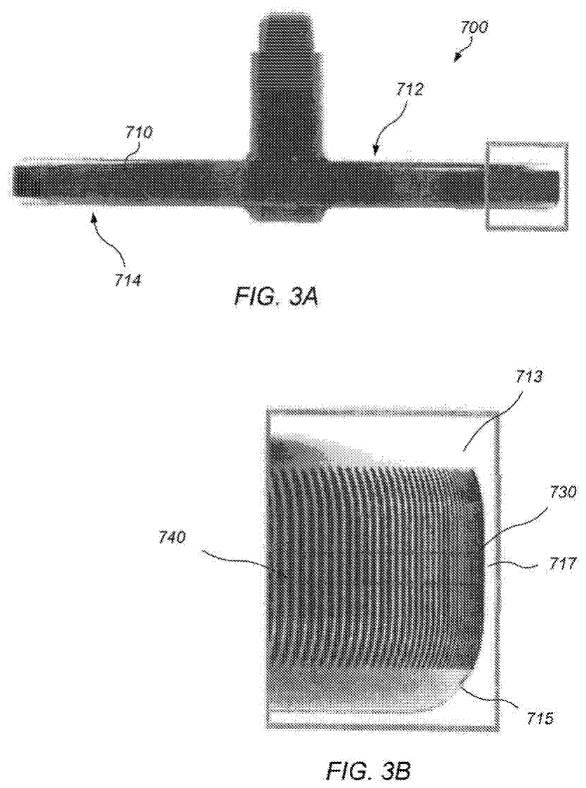

FIGS. 1A-B depict an embodiment of a fiber producing device 300 with draft members 312 positioned outside of a ring portion 314 of the body of the fiber producing device. Channel 316 may function as a material input channel, wherein material is positioned in the channel before being spun out of openings in members 312 and produced into fibers. As depicted in the cross section of FIG. 3B, draft members 312 may include a channel 322. Channels 322 may function to connect openings 324 with channel 316 to produce fibers during use. In some embodiments, the body may be formed from layers of insulating material 326 and heat transmitting material 328. Coupling member 318 may function to couple fiber producing device 300 to a drive system of a fiber producing system. In some embodiments, a top surface of exterior ring portion 314 may be compatible with an inductive heating system.

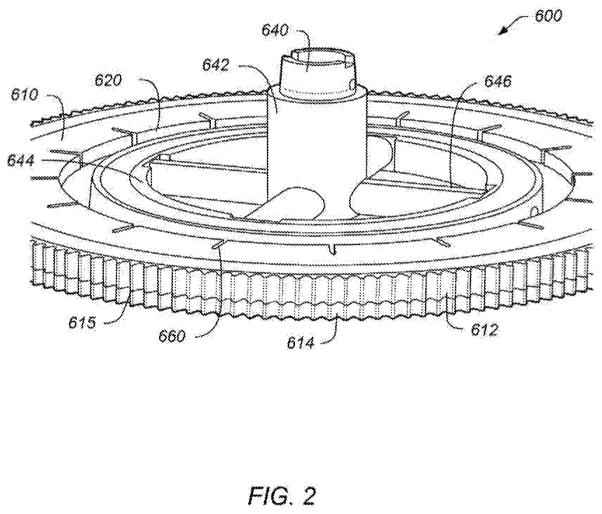

FIG. 2 depicts a projection view of another embodiment of a fiber producing device. Fiber producing device 600 includes a gear like body 610, having a plurality of orifices 615 disposed on the tip of the “tooth” of each gear like extension. Body 610 may be composed of a top member 612 and a bottom member 614. Top member 612 and bottom member 614 together define a body cavity (not shown), in which the material to be formed into fibers is disposed. An opening 620 extends through top member 612 to the body cavity to allow material to be placed into body cavity. Use of a channel that couples directly to the body cavity allows introduction of the material from the top face of the body while the body is being rotated. Fiber producing device 600 is coupled to a drive using coupling member 640. Coupling member, in some embodiments, has an open hub design. An open hub design features a central coupler 642 which is connected to a coupling ring 644 through one or more arms 646, leaving a substantially empty area between the central coupler and the coupling ring. This open hub design helps improve air flow management around the fiber producing device.

Fiber producing devices may be heated by induction, as described herein. Induction produces currents in the body of the fiber producing device which heats the device. It is often desirable to control the location of the heating by steering the induced currents to the regions where heat is desired. In FIG. 2, a fiber producing device has radial slots 660 cut in the upper plate to push induced circumferential currents to the outer diameters of the device.

In a fiber producing system where the fibers are laid down on a substrate perpendicular to the axis of rotation, below the fiber producing device, it is important that the spread of the fibers be controlled such that the deposited fibers are as uniform as possible across the deposition width. Several system parameters influence, and can be altered, to control the spread of fibers.

For example, rotational velocity, chamber air flow, and distance between the fiber producing device and the substrate are among the system parameters that may be easily modified.

An additional parameter that may be used to modify the spread of fibers is the air flow at the openings of the fiber producing device. One way to control the air flow at the openings of a fiber producing device is to alter the shape of the body. It has been found that the body of a fiber producing device can be shaped in a way such that the air flow between the top surface and the bottom surface of the body creates different velocities in the vicinity of the openings. Thus the fiber trajectory may be controlled by changing the shape of the body. Generally, the shape of the sides of the body have the most effect on the airflow around the openings. For example, varying the diameter between the top surface and the bottom surface of the body of a fiber producing device can create different air flows proximate to the openings.

FIGS. 3A-B depict an embodiment of a fiber producing device 700. Fiber producing device 700 includes a substantially circular body 710 having an internal cavity. One or more openings 730 are formed in the sidewalls of the fiber producing device communicating with the internal cavity. Openings 730 may include two rows of openings arranged as two substantially parallel lines of openings. Both lines are spaced an equal distance from center 717 of body 710. A coupling member 720 is coupled to the body. The coupling member is used to couple body 710 to a driver.

In one embodiment, the diameter of the body varies between a top surface 712 and a bottom surface 714. In this embodiment, the body has a symmetrical profile. For example, body 710 has a rounded top portion 713 and a rounded bottom portion 715. Thus body 710 has a diameter at top portion 713 that is less than the diameter at center 717 of the body and a diameter at bottom portion 715 that is less than the diameter at center 717 of the body. The reduced diameter of the top and bottom portions of body 710 creates a predefined airflow in a region proximate to the openings. The predefined airflow enhances the movement of the fibers away from the fiber producing device in a manner that will help ensure a more even distribution of the fibers when deposited on a substrate. The profile of fiber producing device 700 is such that central portion 717 of body 710 is substantially vertical, and lies in a line parallel with the axis of rotation. The portion of body 710 proximate to the top portion and the bottom portion may be substantially rounded to create the varying diameter for the body. Body 710 further includes a plurality of vertical grooves 740, formed in the sidewalls, the vertical grooves enhance the flow of air around the openings 730.

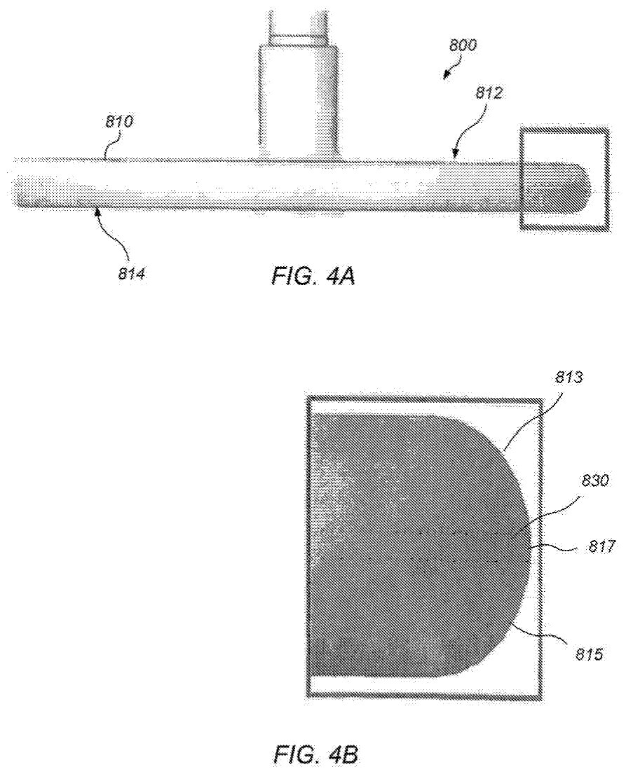

FIGS. 4A-B depict an embodiment of a fiber producing device 800. Fiber producing device 800 includes a substantially circular body 810 having an internal cavity. One or more openings 830 are formed in the sidewalls of the fiber producing device communicating with the internal cavity. Openings 830 may include two rows of openings arranged as two substantially parallel lines of openings. Both lines are spaced an equal distance from center 817 of body 810. A coupling member 820 is coupled to the body. The coupling member is used to couple body 810 to a driver.

In one embodiment, the diameter of the body varies between a top surface 812 and a bottom surface 814. In this embodiment, the body has a symmetrical profile. For example, body 810 has a rounded top portion 813 and a rounded bottom portion 815. Thus body 810 has a diameter at top portion 813 that is less than the diameter at center 817 of the body and a diameter at bottom portion 815 that is less than the diameter at center 817 of the body. The reduced diameter of the top and bottom portions of body 810 creates a predefined airflow in a region proximate to the openings. The predefined airflow enhances the movement of the fibers away from the fiber producing device in a manner that will help ensure a more even distribution of the fibers when deposited on a substrate. The profile of fiber producing device 800 is substantially rounded from center 817 to top surface 812 and from the center to the bottom surface 814 to create the varying diameter for the body.

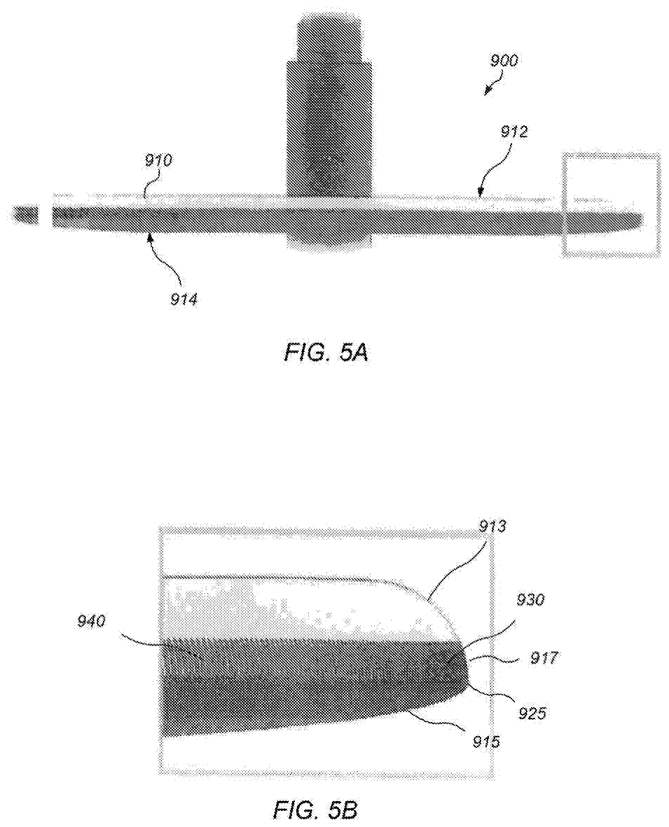

FIGS. 5A-B depict an embodiment of a fiber producing device 900. Fiber producing device 900 includes a substantially circular body 910 having an internal cavity. One or more openings 930 are formed in the sidewalls of the fiber producing device communicating with the internal cavity. Openings 930 may include a single row of openings or two rows of openings arranged as two substantially parallel lines of openings. When two lines of openings are present, both lines are spaced an equal distance from center 917 of body 910. A coupling member 920 is coupled to the body. The coupling member is used to couple body 910 to a driver. It should be understood that two lines of openings is merely illustrative, the number of lines of openings may be two or more.

In one embodiment, the diameter of the body varies between a top surface 912 and a bottom surface 914. In this embodiment, the body has an asymmetrical profile. Body 910 has a rounded top portion 913 and a rounded bottom portion 915. Thus body 910 has a diameter at top portion 913 that is less than the diameter at center 917 of the body and a diameter at bottom portion 915 that is less than the diameter at center 917 of the body. The reduced diameter of the top and bottom portions of body 910 creates a predefined airflow in a region proximate to the openings. The predefined airflow enhances the movement of the fibers away from the fiber producing device in a manner that will help ensure a more even distribution of the fibers when deposited on a substrate. The profile of fiber producing device 900 is asymmetrical. Thus the top portion is substantially rounded from an off center position 925 to top surface 912 and from the off center position 925 to the bottom surface 914 to create an asymmetrical profile. Body 910 further includes a plurality of vertical grooves 940, formed in the sidewalls, the vertical grooves enhance the flow of air around the openings 930.

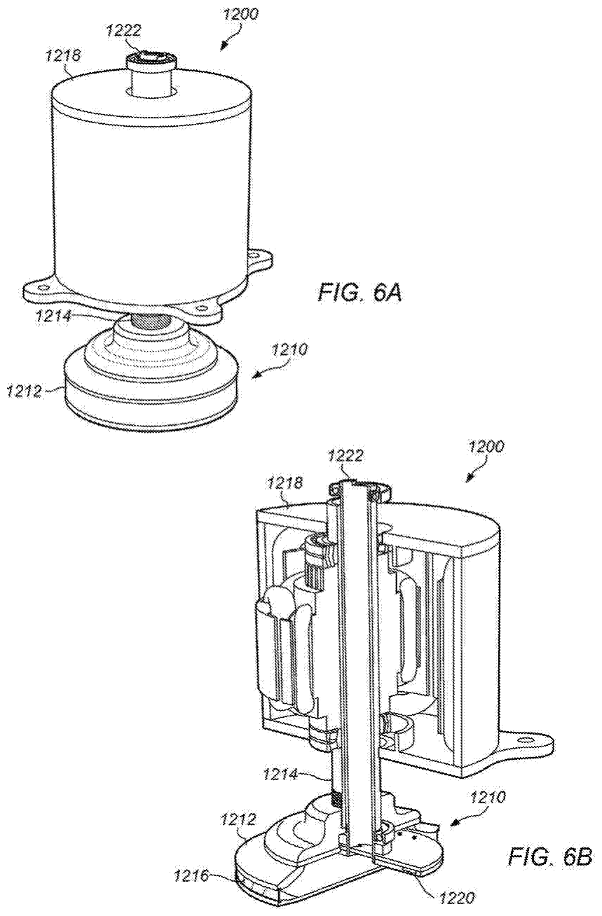

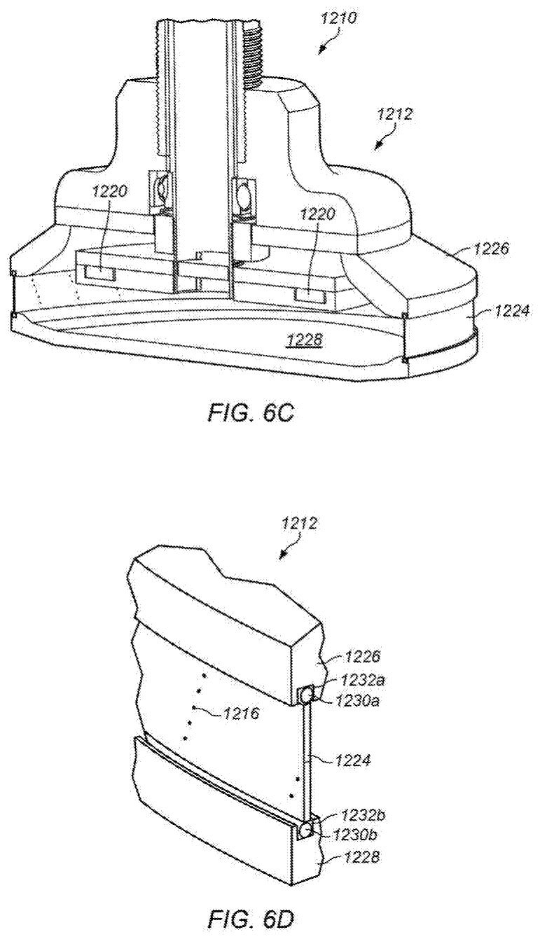

In an embodiment of a fiber producing system, a heating device may be positioned substantially inside a body of a fiber producing device. An embodiment of a fiber producing system is depicted in FIGS. 6A-D. Fiber producing system 1200 includes a fiber producing device 1210. Fiber producing device 1210 includes a body 1212 and a coupling member 1214. Body 1212 comprises one or more openings 1216 through which material disposed in the body may pass through during use. As discussed previously, interior cavity of the body may include angled or rounded walls to help direct material disposed in body 1212 toward openings 1216. In some embodiments, an interior cavity of body 1212 may have few or no angled or rounded walls to help direct material disposed in body 1212 because such angled walls are not necessary due to the material and/or the speed at which the body is spinning during the process. Coupling member 1214 may be an elongated member extending from the body which may be coupled to a driver 1218. Alternatively, coupling member may be a receiver which will accept an elongated member from a driver (e.g., the coupling member may be a chuck or a universal threaded joint).

In some embodiment, fiber producing device 1210 may include internal heating device 1220 (e.g., depicted in FIGS. 6B-C). Heating device 1220 may function to heat material conveyed into body 1212 facilitating the production of fibers as the material is conveyed through one or more openings 1216. Heating device 1220 may heat material inductively or radiantly. In some embodiments, a heating device may heat material conductively, inductively or radiantly. In some embodiments, a heating device may heat material using RF, lasers, or infrared.

In some embodiments, heating device 1220 may move during use. Heating device 1220 may move in coordination with body 1212 during use. Heating device 1220 may be coupled to coupling member 1214.

In some embodiments, heating device 1220 may remain substantially motionless in relation to body 1212 during use such that as body 1212 spins, heating device 1220 remains relatively motionless. In some embodiments, heating device 1220 may be coupled to elongated conduit 1222. Elongated conduit 1222 may be at least partially positioned in coupling member 1224. Elongated conduit 1222 may move independently of coupling member 1224 such that as the coupling member rotates body 1212 rotates without moving elongated conduit 1222. In some embodiments, elongated conduit 1222 may supply power to heating device 1220.

In some embodiments, materials used to form fibers may be conveyed into a body of a fiber producing device. In some embodiments, the material may be conveyed to the body under pressure. Pressurized feed of materials into a fiber producing device may facilitate fiber production by forcing the materials through the openings in addition to the force provided by the spinning body of the device. A pressurized feed system may allow for produced fibers to be ejected from the openings at a higher velocity. A pressurized feed system may also allow for cleaning the fiber producing device by conveying gasses and/or solvents under pressure through the device to facilitate cleaning. In some embodiments, elongated conduit 1222 may function to convey materials to body 1212. Elongated conduit 1222 may in some embodiments convey materials through driver 1218 (e.g., as depicted in FIG. 6B). Conveying materials through the elongated conduit may allow for the material to be delivered in an atmosphere other than air/oxygen. Materials may be conveyed using an inert atmosphere such as argon or nitrogen.

In some embodiments, a driver may include a direct drive coupled to a body of a fiber producing device. A direct drive system may increase the efficiency of the fiber producing system. Direct drive mechanisms are typically devices that take the power coming from a motor without any reductions (e.g., a gearbox). In addition to increased efficiency a direct drive has other advantages including reduced noise, longer lifetime, and providing high torque a low rpm. Elongated conduit 1222 may in some embodiments convey materials through driver 1218 (e.g., as depicted in FIG. 6B), in some embodiments driver 1218 may include a direct driver.

FIG. 6D depicts an embodiment of a cross section of a body 1212 of a portion of a sidewall 1224, top member 1226, and bottom member 1228 of a fiber producing system. Fiber producing system 1200 includes a fiber producing device 1210. Fiber producing device 1210 includes a body 1212 and a coupling member 1214. Body 1212 comprises one or more openings 1216 through which material disposed in the body may pass through during use. Sidewall 1224 may include a plurality of openings 1216. In some embodiments, the plurality of openings may include a patterned array of openings. The patterned array may include a repeating pattern. The pattern may be such that no opening in the pattern is aligned vertically with another opening. The pattern may be such as to include a minimum distance between openings horizontally. In some embodiments, a pattern may inhibit entwining of fibers. Inhibition of fiber entwining or “roping” may result in a more consistent fiber product and better product.

Different patterns of openings may be desired and/or one or more openings may become clogged during normal use. In some embodiments, sidewall 1224 of body 1212 may be replaced without having to replace any other components of a fiber producing device. Sidewall 1224 may be coupleable to top member 1226, and bottom member 1228 of a fiber producing system. Edges 1230a and 1230b of a sidewall may fit within channels 1232a and 1232b of top member 1226 and bottom member 1228 respectively. Edges 1230 may function to couple sidewall 1224 to top member 1226 and bottom member 1228. In some embodiments, the edges of the sidewall may form a friction fit with the channels of the top and bottom members. In some embodiments, the edges of the sidewall may have a cross section similar to a cross section of the channels of the top and bottom members such that the edges may slide into the channels in a lateral direction but inhibited from being pulled out of the channels in any other direction.

In an embodiment, a heating device used to heat a fiber producing device is a radiant heater. An infrared heater is an example of a radiant heater that may be used to heat a fiber producing device. In some embodiments, a heating device may include an infrared heating device. An infrared heating device may include a device which is tuned or tuneable to a specific infrared wavelength. An infrared wavelength may be chosen based upon what type of material is being heated.

Infrared radiant heating is used extensively in industry, particularly for drying of materials or fusing of coatings (e.g., powder coating, drying of paints or printed layers). Infrared heating has advantages over other forms of heating, in that the emitted radiation (if appropriately specified) is only absorbed by the substrate (or treated potions of the substrate) and not by the surrounding air or objects. Infrared heating may be defined as applying radiant energy to the part surface by direct transmission from an emitter (source). Some of the energy emitted may be reflected off the surface, some may be absorbed by the substrate and some may be transmitted though the substrate. The absorption characteristics may depend on the type of material, the color, and the surface finish. For example, a rough, black object will absorb more infrared energy than will a smooth white object which reflects more energy. The actual behavior of infrared energy depends on the wavelength, the distance between the substrate and the emitter, the mass of the part, the surface area and the color sensitivity. Generally shorter wavelength infrared radiation penetrates further into the substrate but is more sensitive to changes in the color of the substrate. Generally speaking, polymers absorb more effectively in the medium infrared range.

When radiation is applied to a polymer surface it can be reflected, transmitted, or absorbed. It is the absorbed portion that leads to temperature increase and consequently leads to melting of the polymer. The amount of radiation absorbed by a pure unfilled thermoplastic is determined by the vibrations of its atoms. For a vibration to be infrared-active, it must be associated with a change in dipole moment which can be activated by the oscillating electric field of incident infrared radiation. Certain vibrational modes have frequencies within the infrared spectrum and can therefore absorb infrared radiation of specific wavelengths. Plastic materials absorb infrared radiation at wavelengths from about 2 to about 15 μm. Wavelengths of 3.3 to 3.5 μm correspond to vibrational modes of C—H bonds; alcohol, carboxylic acid, or amide groups absorb infrared energy at wavelengths of about 2 to about 3 μm. Absorption of infrared radiation induces molecular vibrations (e.g., stretching, rocking, etc.) which increase the temperature of the organic polymer. Infrared heating device therefore may have several advantages including restricting heating energy to the desired material. In this way less energy is wasted during the heating process because it is directed towards a specific material.

In some embodiments, a heating device (e.g., an infrared heating device) may be positioned to heat materials before and/or as they enter the body of a fiber producing device. In some embodiments, an infrared heating device may be positioned at least partially in the interior of a fiber producing device. In such embodiments, an infrared heating device may heat material conveyed through a body of the fiber producing device. The infrared heating device may function to heat the material such that the material melts such that when the body spins the material passes through openings in the body to produce fibers. The infrared heating device may further heat material in the body which was previously melted prior to introduction into the body. The infrared heating device may further heat material in the body which was previously melted prior to introduction into the body. Further heating material may function to decrease the viscosity of the material. Further heating material may function to decrease the viscosity of the material such that flowing of the material through the openings is facilitated.

In some embodiments, an infrared heating system may be used to heat at least a portion of the environment substantially adjacent to a body of the fiber producing device. Specifically the infrared heating system may be used to heat at least a portion of the environment substantially adjacent to a plurality of openings in the body through which the material is conveyed in order to produce the fibers. Heating the environment around the body of the fiber producing device may allow for longer fibers to be produced by extending the quench rate of fibers exiting the openings in the body of the fiber producing device. By adjusting the infrared heating device one may adjust a length of the fibers produced by the fiber producing device.

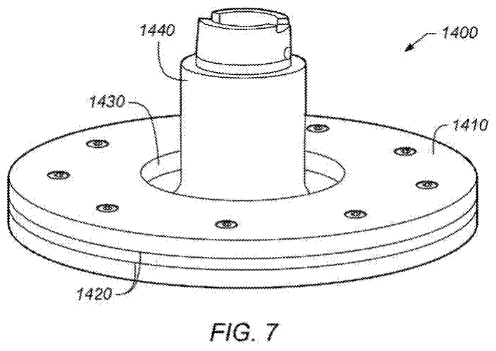

FIGS. 7 and 8 depict an alternate embodiment of a fiber producing device. Fiber producing device 1400 includes a body 1410, having a plurality of orifices disposed in slot 1420. Body 1410 may be composed of two or more members. In the embodiment depicted a grooved member 1414 is placed on grooved support 1418. Support 1418 provides a base upon which the grooved members may be stacked. Support 1418 also includes a coupling member 1430 which may be used to couple fiber producing device 1400 to a driver. While two grooved members are depicted, it should be understood that more or less grooved members may be used.

In one embodiment, fiber producing device 1400 includes a top member 1412 and a support member 1418 with one or more grooved members (1414, 1416) sandwiched between the top member and the support member. To assemble fiber producing device 1400, a first grooved member 1416 is placed on support 1418. A seal (not shown) may be disposed between grooved member 1416 and support 1418. A second grooved member 1414 is placed on first grooved member 1416. A seal (not shown) may be disposed between second grooved member 1414 and first grooved member 1416. When coupled together first grooved member 1416 and second grooved member 1414 define slot 1420, which runs around the circumference of the fiber producing device. Top member 1412 is placed on second grooved member 1414 and is fastened to support member 1418 by fasteners 1440, which extend through the top member, first, and second groove members into the support member. A seal (not shown) may be disposed between top member 1412 and second grooved member 1414. When coupled together top member 1412 and second grooved member 1414 define a slot 1420, which runs around the circumference of the fiber producing device.

When fiber producing device 1400 is assembled, a body cavity 1430 is defined by support member 1418, grooved members 1416 and 1414, and top member 1412. Material may be placed into body cavity 1460 during use. A plurality of grooves 1450 are formed in grooved members 1414 and 1416. When fiber producing device 1400 is rotated, material disposed in body cavity 1460 enters grooves 1450, which transports the material through the fiber producing device to be ejected through openings at slot 1420.

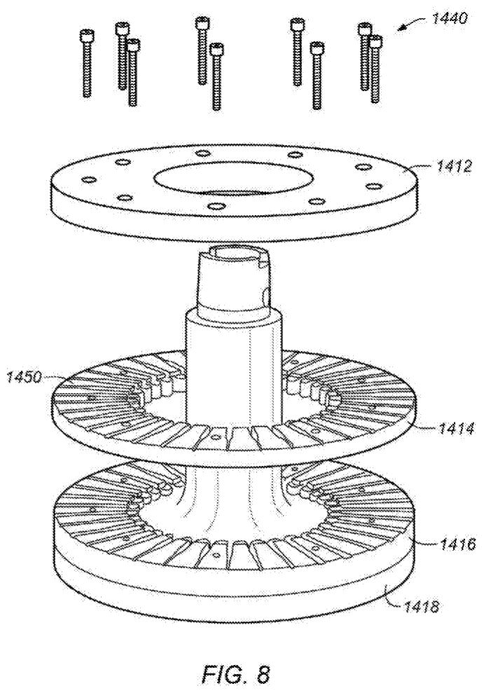

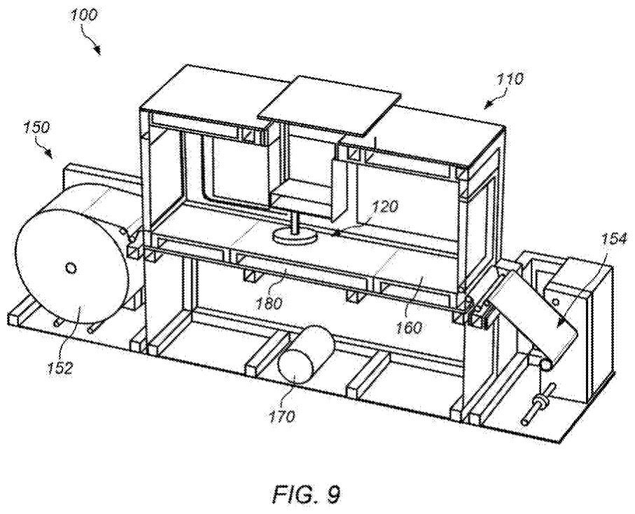

An embodiment of a system 100 for depositing fibers onto a substrate is depicted in FIG. 9. System 100 includes a fiber producing system 110 and a substrate transfer system 150. Fiber producing system 110 includes a fiber producing device 120, as described herein. Fiber producing system produces and directs fibers produced by a fiber producing device toward a substrate 160 disposed below the fiber producing device during use. Substrate transfer system moves a continuous sheet of substrate material through the deposition system.

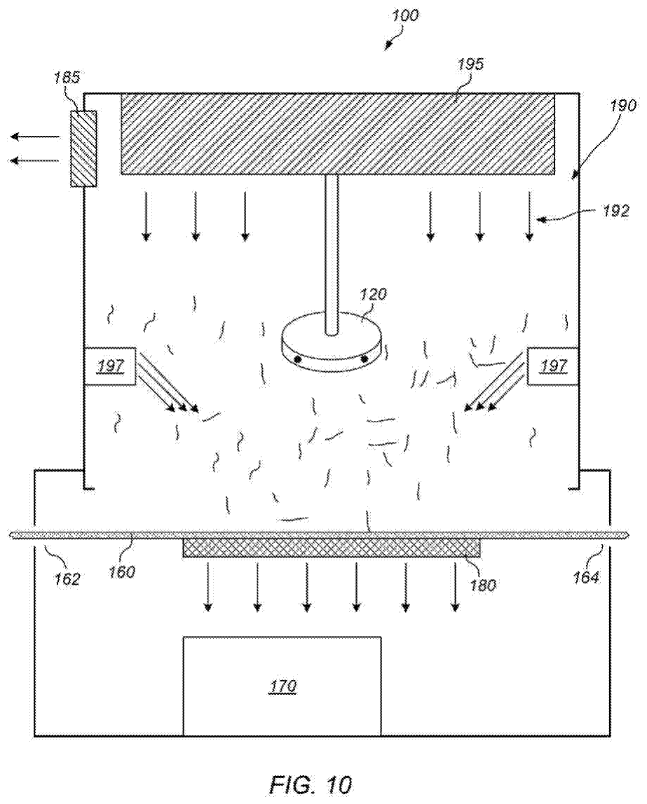

System 100, in one embodiment, includes a top mounted fiber producing device 120. During use, fibers produced by fiber producing device 120 are deposited onto substrate 160. A schematic diagram of system 100 is depicted in FIG. 10. Fiber producing system 110 may include one or more of: a vacuum system 170, an electrostatic plate 180, and a gas flow system 190. A vacuum system produces a region of reduced pressure under substrate 160 such that fibers produced by fiber producing device 110 are drawn toward the substrate due to the reduced pressure. Alternatively, one or more fans may be positioned under the substrate to create an air flow through the substrate. Gas flow system 190 produces a gas flow 192 that directs fibers formed by the fiber producing device toward the substrate. Gas flow system may be a pressurized air source or one or more fans that produce a flow of air (or other gases). The combination of vacuum and air flow systems are used to produce a “balanced air flow” from the top of the deposition chamber through the substrate to the exhaust system by using forced air (fans, pressurized air) and exhaust air (fans, to create an outward flow) and balancing and directing the airflow to produce a fiber deposition field down to the substrate. System 100 includes substrate inlet 162 and substrate outlet 164.

An electrostatic plate 180 is also positioned below substrate 160. The electrostatic plate is a plate capable of being charged to a predetermined polarity. Typically, fibers produced by the fiber producing device have a net charge. The net charge of the fibers may be positive or negative, depending on the type of material used. To improve deposition of charged fibers, electrostatic plate 180 may be disposed below substrate 160 and be charged to an opposite polarity as the produced fibers. In this manner, the fibers are attracted to the electrostatic plate due to the electrostatic attraction between the opposite charges. The fibers become embedded in the substrate as the fibers move toward the electrostatic plate.

A pressurized gas producing and distribution system may be used to control the flow of fibers toward a substrate disposed below the fiber producing device. During use, fibers produced by the fiber producing device are dispersed within the deposition system. Since the fibers are composed primarily of microfibers and/or nanofibers, the fibers tend to disperse within the deposition system. The use of a pressurized gas producing and distribution system may help guide the fibers toward the substrate. In one embodiment, a gas flow system 190 includes a downward gas flow device 195 and a lateral gas flow device 197. Downward gas flow device 195 is positioned above or even with the fiber producing device to facilitate even fiber movement toward the substrate. One or more lateral gas flow devices 197 are oriented perpendicular to or below the fiber producing device. In some embodiment, lateral gas flow devices 197 have an outlet width equal to the substrate width to facilitate even fiber deposition onto substrate. In some embodiments, the angle of the outlet of one or more lateral gas flow devices 197 may be varied to allow better control of the fiber deposition onto the substrate. Each lateral gas flow devices 197 may be independently operated.

During use of the deposition system, fiber producing device 120 may produce various gasses due to evaporation of solvents (during solution spinning) and material gasification (during melt spinning). Such gasses, if accumulated in the deposition system may begin to affect the quality of the fiber produced. In some embodiment, the deposition system includes an outlet fan 185 to remove gasses produced during fiber production from the deposition system.

Substrate transfer system 150, in one embodiment depicted in FIG. 9, is capable of moving a continuous sheet of substrate material through the deposition system. In one embodiment, substrate transfer system 150 includes a substrate reel 152 and a take up reel system 154. During use, a roll of substrate material is placed on substrate reel 152 and threaded through system 100 to the substrate take up reel system 154. During use, substrate take up reel system 154 rotates, pulling substrate through deposition system at a predetermined rate. In this manner, a continuous roll of a substrate material may be pulled through fiber deposition system.

Further embodiments of deposition systems are described in U.S. Published Patent Application No. 2014/0159262, which is incorporated herein by reference.

Fibers represent a class of materials that are continuous filaments or that are in discrete elongated pieces, similar to lengths of thread. Fibers are of great importance in the biology of both plants and animals, e.g., for holding tissues together. Human uses for fibers are diverse. For example, fibers may be spun into filaments, thread, string, or rope. Fibers may also be used as a component of composite materials. Fibers may also be matted into sheets to make products such as paper or felt. Fibers are often used in the manufacture of other materials.

Fibers as discussed herein may be created using, for example, a solution spinning method or a melt spinning method. In both the melt and solution spinning methods, a material may be put into a fiber producing device which is spun at various speeds until fibers of appropriate dimensions are made. The material may be formed, for example, by melting a solute or may be a solution formed by dissolving a mixture of a solute and a solvent. Any solution or melt familiar to those of ordinary skill in the art may be employed. For solution spinning, a material may be designed to achieve a desired viscosity, or a surfactant may be added to improve flow, or a plasticizer may be added to soften a rigid fiber. In melt spinning, solid particles may comprise, for example, a metal, ceramic, or a polymer, wherein polymer additives may be combined with the latter. Certain materials may be added for alloying purposes (e.g., metals) or adding value (such as antioxidant or colorant properties) to the desired fibers.

Non-limiting examples of reagents that may be melted, or dissolved or combined with a solvent to form a material for melt or solution spinning methods include polyolefin, polyacetal, polyamide, polyester, polyurethane, cellulose ether and ester (e.g., cellulose acetate, cellulose diacetate, cellulose triacetate, etc.), polyalkylene sulfide, polyarylene oxide, polysulfone, modified polysulfone polymers and mixtures thereof. Non-limiting examples of solvents that may be used include oils, lipids and organic solvents such as DMSO, toluene, low boiling organic acids (e.g., formic acid, acetic acid, etc.) and alcohols. Water, such as de-ionized water, may also be used as a solvent. For safety purposes, non-flammable solvents are preferred.

In either the solution or melt spinning method, as the material is ejected from the spinning fiber producing device, thin jets of the material are simultaneously stretched and dried or stretched and cooled in the surrounding environment. Interactions between the material and the environment at a high strain rate (due to stretching) leads to solidification of the material into fibers, which may be accompanied by evaporation of solvent. By manipulating the temperature and strain rate, the viscosity of the material may be controlled to manipulate the size and morphology of the fibers that are created. A wide variety of fibers may be created using the present methods, including novel fibers such as polypropylene (PP) nanofibers. Non-limiting examples of fibers made using the melt spinning method include polypropylene, acrylonitrile butadiene styrene (ABS) and nylon. Non-limiting examples of fibers made using the solution spinning method include polyethylene oxide (PEO) and beta-lactams.

The creation of fibers may be done in batch modes or in continuous modes. In the latter case, material can fed continuously into the fiber producing device and the process can be continued over days (e.g., 1-7 days) and even weeks (e.g., 1-4 weeks).

The methods discussed herein may be used to create, for example, nanocomposites and functionally graded materials that can be used for fields as diverse as, for example, drug delivery and ultrafiltration (such as electrets). Metallic and ceramic nanofibers, for example, may be manufactured by controlling various parameters, such as material selection and temperature. At a minimum, the methods and apparatuses discussed herein may find application in any industry that utilizes micro- to nano-sized fibers and/or micro- to nano-sized composites. Such industries include, but are not limited to, material engineering, mechanical engineering, military/defense industries, biotechnology, medical devices, tissue engineering industries, food engineering, drug delivery, electrical industries, or in ultrafiltration and/or micro-electric mechanical systems (MEMS).

Some embodiments of a fiber producing device may be used for melt and/or solution processes. Some embodiments of a fiber producing device may be used for making organic and/or inorganic fibers. With appropriate manipulation of the environment and process, it is possible to form fibers of various configurations, such as continuous, discontinuous, mat, random fibers, unidirectional fibers, woven and nonwoven, as well as fiber shapes, such as circular, elliptical and rectangular (e.g., ribbon). Other shapes are also possible. The produced fibers may be single lumen or multi-lumen.

By controlling the process parameters, fibers can be made in micron, sub-micron and nano-sizes, and combinations thereof. In general, the fibers created will have a relatively narrow distribution of fiber diameters. Some variation in diameter and cross-sectional configuration may occur along the length of individual fibers and between fibers.

Generally speaking, a fiber producing device helps control various properties of the fibers, such as the cross-sectional shape and diameter size of the fibers. More particularly, the speed and temperature of a fiber producing device, as well as the cross-sectional shape, diameter size and angle of the outlets in a fiber producing device, all may help control the cross-sectional shape and diameter size of the fibers. Lengths of fibers produced may also be influenced by the choice of fiber producing device used.

The temperature of the fiber producing device may influence fiber properties, in certain embodiments. Both resistance and inductance heaters may be used as heat sources to heat a fiber producing device. In certain embodiments, the fiber producing device is thermally coupled to a heat source that may be used to adjust the temperature of the fiber producing device before spinning, during spinning, or both before spinning and during spinning. In some embodiments, the fiber producing device is cooled. For example, a fiber producing device may be thermally coupled to a cooling source that can be used to adjust the temperature of the fiber producing device before spinning, during spinning, or before and during spinning. Temperatures of a fiber producing device may range widely. For example, a fiber producing device may be cooled to as low as −20° C. or heated to as high as 2500° C. Temperatures below and above these exemplary values are also possible. In certain embodiments, the temperature of a fiber producing device before and/or during spinning is between about 4° C. and about 400° C. The temperature of a fiber producing device may be measured by using, for example, an infrared thermometer or a thermocouple.

The speed at which a fiber producing device is spun may also influence fiber properties. The speed of the fiber producing device may be fixed while the fiber producing device is spinning, or may be adjusted while the fiber producing device is spinning. Those fiber producing devices whose speed may be adjusted may, in certain embodiments, be characterized as variable speed fiber producing devices. In the methods described herein, the fiber producing device may be spun at a speed of about 500 RPM to about 25,000 RPM, or any range derivable therein. In certain embodiments, the fiber producing device is spun at a speed of no more than about 50,000 RPM, about 45,000 RPM, about 40,000 RPM, about 35,000 RPM, about 30,000 RPM, about 25,000 RPM, about 20,000 RPM, about 15,000 RPM, about 10,000 RPM, about 5,000 RPM, or about 1,000 RPM. In certain embodiments, the fiber producing device is rotated at a rate of about 5,000 RPM to about 25,000 RPM.

In an embodiment, a method of creating fibers, such as microfibers and/or nanofibers, includes: heating a material; placing the material in a heated fiber producing device; and, after placing the heated material in the heated fiber producing device, rotating the fiber producing device to eject material to create nanofibers from the material. In some embodiments, the fibers may be microfibers and/or nanofibers. A heated fiber producing device is a structure that has a temperature that is greater than ambient temperature. “Heating a material” is defined as raising the temperature of that material to a temperature above ambient temperature. “Melting a material” is defined herein as raising the temperature of the material to a temperature greater than the melting point of the material, or, for polymeric materials, raising the temperature above the glass transition temperature for the polymeric material. In alternate embodiments, the fiber producing device is not heated. Indeed, for any embodiment that employs a fiber producing device that may be heated, the fiber producing device may be used without heating. In some embodiments, the fiber producing device is heated but the material is not heated. The material becomes heated once placed in contact with the heated fiber producing device. In some embodiments, the material is heated and the fiber producing device is not heated. The fiber producing device becomes heated once it comes into contact with the heated material.

A wide range of volumes/amounts of material may be used to produce fibers. In addition, a wide range of rotation times may also be employed. For example, in certain embodiments, at least 5 milliliters (mL) of material are positioned in a fiber producing device, and the fiber producing device is rotated for at least about 10 seconds. As discussed above, the rotation may be at a rate of about 500 RPM to about 25,000 RPM, for example. The amount of material may range from mL to liters (L), or any range derivable therein. For example, in certain embodiments, at least about 50 mL to about 100 mL of the material are positioned in the fiber producing device, and the fiber producing device is rotated at a rate of about 500 RPM to about 25,000 RPM for about 300 seconds to about 2,000 seconds. In certain embodiments, at least about 5 mL to about 100 mL of the material are positioned in the fiber producing device, and the fiber producing device is rotated at a rate of 500 RPM to about 25,000 RPM for 10-500 seconds. In certain embodiments, at least 100 mL to about 1,000 mL of material is positioned in the fiber producing device, and the fiber producing device is rotated at a rate of 500 RPM to about 25,000 RPM for about 100 seconds to about 5,000 seconds. Other combinations of amounts of material, RPMs and seconds are contemplated as well.

Typical dimensions for fiber producing devices are in the range of several inches in diameter and several inches in height. In some embodiments, a fiber producing device has a diameter of between about 1 inch to about 60 inches, from about 2 inches to about 30 inches, or from about 5 inches to about 25 inches. The height of the fiber producing device may range from about 0.5 inch to about 10 inches, from about 2 inches to about 8 inches, or from about 3 inches to about 5 inches.

In certain embodiments, fiber producing device includes at least one opening and the material is extruded through the opening to create the nanofibers. In certain embodiments, the fiber producing device includes multiple openings and the material is extruded through the multiple openings to create the nanofibers. These openings may be of a variety of shapes (e.g., circular, elliptical, rectangular, square) and of a variety of diameter sizes (e.g., 0.01-0.80 mm). When multiple openings are employed, not every opening need be identical to another opening, but in certain embodiments, every opening is of the same configuration. Some openings may include a divider that divides the material, as the material passes through the openings. The divided material may form multi-lumen fibers.

In an embodiment, material may be positioned in a reservoir of a fiber producing device. The reservoir may, for example, be defined by a concave cavity of the heated structure. In certain embodiments, the heated structure includes one or more openings in communication with the concave cavity. The fibers are extruded through the opening while the fiber producing device is rotated about a spin axis. The one or more openings have an opening axis that is not parallel with the spin axis. The fiber producing device may include a body that includes the concave cavity and a lid positioned above the body.

Another fiber producing device variable includes the material(s) used to make the fiber producing device. Fiber producing devices may be made of a variety of materials, including metals (e.g., brass, aluminum, stainless steel) and/or polymers. The choice of material depends on, for example, the temperature the material is to be heated to, or whether sterile conditions are desired.

Any method described herein may further comprise collecting at least some of the microfibers and/or nanofibers that are created. As used herein “collecting” of fibers refers to fibers coming to rest against a fiber collection device. After the fibers are collected, the fibers may be removed from a fiber collection device by a human or robot. A variety of methods and fiber (e.g., nanofiber) collection devices may be used to collect fibers.

Regarding the fibers that are collected, in certain embodiments, at least some of the fibers that are collected are continuous, discontinuous, mat, woven, nonwoven or a mixture of these configurations. In some embodiments, the fibers are not bundled into a cone shape after their creation. In some embodiments, the fibers are not bundled into a cone shape during their creation. In particular embodiments, fibers are not shaped into a particular configuration, such as a configuration, using gas, such as ambient air, that is blown onto the fibers as they are created and/or after they are created.

Present method may further comprise, for example, introducing a gas through an inlet in a housing, where the housing surrounds at least the heated structure. The gas may be, for example, nitrogen, helium, argon, or oxygen. A mixture of gases may be employed, in certain embodiments.

The environment in which the fibers are created may comprise a variety of conditions. For example, any fiber discussed herein may be created in a sterile environment. As used herein, the term “sterile environment” refers to an environment where greater than 99% of living germs and/or microorganisms have been removed. In certain embodiments, “sterile environment” refers to an environment substantially free of living germs and/or microorganisms. The fiber may be created, for example, in a vacuum. For example the pressure inside a fiber producing system may be less than ambient pressure. In some embodiments, the pressure inside a fiber producing system may range from about 1 millimeters (mm) of mercury (Hg) to about 700 mm Hg. In other embodiments, the pressure inside a fiber producing system may be at or about ambient pressure. In other embodiments, the pressure inside a fiber producing system may be greater than ambient pressure. For example the pressure inside a fiber producing system may range from about 800 mm Hg to about 4 atmospheres (atm) of pressure, or any range derivable therein.

In certain embodiments, the fiber is created in an environment of 0-100% humidity, or any range derivable therein. The temperature of the environment in which the fiber is created may vary widely. In certain embodiments, the temperature of the environment in which the fiber is created can be adjusted before operation (e.g., before rotating) using a heat source and/or a cooling source. Moreover, the temperature of the environment in which the fiber is created may be adjusted during operation using a heat source and/or a cooling source. The temperature of the environment may be set at sub-freezing temperatures, such as −20° C., or lower. The temperature of the environment may be as high as, for example, 2500° C.

The material employed may include one or more components. The material may be of a single phase (e.g., solid or liquid) or a mixture of phases (e.g., solid particles in a liquid). In some embodiments, the material includes a solid and the material is heated. The material may become a liquid upon heating. In another embodiment, the material may be mixed with a solvent. As used herein a “solvent” is a liquid that at least partially dissolves the material. Examples of solvents include, but are not limited to, water and organic solvents. Examples of organic solvents include, but are not limited to: hexanes, ether, ethyl acetate, formic acid, acetone, dichloromethane, chloroform, toluene, xylenes, petroleum ether, dimethylsulfoxide, dimethylformamide, or mixtures thereof. Additives may also be present. Examples of additives include, but are not limited to: thinners, surfactants, plasticizers, or combinations thereof

The material used to form the fibers may include at least one polymer. Polymers that may be used include conjugated polymers, biopolymers, water soluble polymers, and particle infused polymers. Examples of polymers that may be used include, but are not limited to polypropylenes, polyethylenes, polyolefins, polyurethanes, polystyrenes, polyesters, fluorinated polymers (fluoropolymers), polyamides, polyaramids, acrylonitrile butadiene styrene, nylons, polycarbonates, beta-lactams, block copolymers or any combination thereof. The polymer may be a synthetic (man-made) polymer or a natural polymer. The material used to form the fibers may be a composite of different polymers or a composite of a medicinal agent combined with a polymeric carrier. Specific polymers that may be used include, but are not limited to chitosan, nylon, nylon-6, polybutylene terephthalate (PBT), polyacrylonitrile (PAN), poly(lactic acid) (PLA), poly(lactic-co-glycolic acid) (PLGA), polyglycolic acid (PGA), polyglactin, polycaprolactone (PCL), silk, collagen, poly(methyl methacrylate) (PMMA), polydioxanone, polyphenylene sulfide (PPS); polyethylene terephthalate (PET), polytetrafluoroethylene (PTFE), polyvinylidene fluoride (PVDF), polypropylene (PP), polyethylene oxide (PEO), acrylonitrile butadiene, styrene (ABS), thermoplastic polyurethane (TPU), Polyurethane (PU), and polyvinylpyrrolidone (PVP). These polymers may be processed as either a melt or as a solution in a suitable solvent.

In another embodiment, the material used to form the fibers may be a metal, ceramic, or carbon-based material. Metals employed in fiber creation include, but are not limited to, bismuth, tin, zinc, silver, gold, nickel, aluminum, or combinations thereof. The material used to form the fibers may be a ceramic such as alumina, titania, silica, zirconia, or combinations thereof The material used to form the fibers may be a composite of different metals (e.g., an alloy such as nitonol), a metal/ceramic composite or ceramic oxides (e.g., PVP with germanium/palladium/platinum).

The fibers that are created may be, for example, one micron or longer in length. For example, created fibers may be of lengths that range from about 1 μm to about 50 cm, from about 100 μm to about 10 cm, or from about 1 mm to about 1 cm. In some embodiments, the fibers may have a narrow length distribution. For example, the length of the fibers may be between about 1 μm to about 9 μm, between about 1 mm to about 9 mm, or between about 1 cm to about 9 cm. In some embodiments, when continuous methods are performed, fibers of up to about 10 meters, up to about 5 meters, or up to about 1 meter in length may be formed.

In certain embodiments, the cross-section of the fiber may be circular, elliptical or rectangular. Other shapes are also possible. The fiber may be a single-lumen fiber or a multi-lumen fiber.

In another embodiment of a method of creating a fiber, the method includes: spinning material to create the fiber; where, as the fiber is being created, the fiber is not subjected to an externally-applied electric field or an externally-applied gas; and the fiber does not fall into a liquid after being created.

Fibers discussed herein are a class of materials that exhibit an aspect ratio of at least 100 or higher. The term “microfiber” refers to fibers that have a minimum diameter in the range of 10 microns to 700 nanometers, or from 5 microns to 800 nanometers, or from 1 micron to 700 nanometers. The term “nanofiber” refers to fibers that have a minimum diameter in the range of 500 nanometers to 1 nanometer; or from 250 nanometers to 10 nanometers, or from 100 nanometers to 20 nanometers.

While typical cross-sections of the fibers are circular or elliptic in nature, they can be formed in other shapes by controlling the shape and size of the openings in a fiber producing device (described below). Fibers may include a blending of multiple materials. Fibers may also include holes (e.g., lumen or multi-lumen) or pores. Multi-lumen fibers may be achieved by, for example, designing one or more exit openings to possess concentric openings. In certain embodiments, such openings may include split openings (that is, wherein two or more openings are adjacent to each other; or, stated another way, an opening possesses one or more dividers such that two or more smaller openings are made). Such features may be utilized to attain specific physical properties, such as thermal insulation or impact absorbance (resilience). Nanotubes may also be created using methods and apparatuses discussed herein.

Fibers may be analyzed via any means known to those of skill in the art. For example, Scanning Electron Microscopy (SEM) may be used to measure dimensions of a given fiber. For physical and material characterizations, techniques such as differential scanning calorimetry (DSC), thermal analysis (TA) and chromatography may be used.

In particular embodiments, a fiber of the present fibers is not a lyocell fiber. Lyocell fibers are described in the literature, such as in U.S. Pat. Nos. 6,221,487, 6,235,392, 6,511,930, 6,596,033 and 7,067,444, each of which is incorporated herein by reference.

In one embodiment, microfibers and nanofibers may be produced substantially simultaneously. Any fiber producing device described herein may be modified such that one or more openings has a diameter and/or shape that produces nanofibers during use, and one or more openings have a diameter and/or shape that produces microfibers during use. Thus, a fiber producing device, when rotated will eject material to produce both microfibers and nanofibers. In some embodiments, nozzles may be coupled to one or more of the openings. Different nozzles may be coupled to different openings such that the nozzles designed to create microfibers and nozzles designed to create nanofibers are coupled to the openings. In an alternate embodiment, needles may be coupled (either directly to the openings or via a needle port). Different needles may be coupled to different openings such that needles designed to create microfibers and needles designed to create nanofibers are coupled to the openings.

Production of microfibers and nanofibers substantially simultaneously may allow a controlled distribution of the fiber size to be achieved, allowing substantial control of the properties of products ultimately produced from the microfiber/nanofiber mixture.

After production of fibers is completed, it is desirable to clean the fiber producing device to allow reuse of the system. Generally, it is easiest to clean a fiber producing device when the material is in a liquid state. Once the material reverts to a solid, cleaning may be difficult, especially cleaning up small diameter nozzles and or needles coupled to the fiber producing device. The difficulty, especially with melt spinning, is that clean up may also be difficult when the device is at an elevated temperature, especially if the fiber producing device needs to be cooled prior to handling for cleanup. In some embodiments, a purge system may be couplable to fiber producing device when the fiber producing device is heated. A purge system may provide an at least partial seal between the purge system and the body of a fiber producing device such that a gas may be directed into the body, through the purge system, to create a pressurized gas inside of the body. The purge system, in some embodiments, includes a sealing member couplable to the body, a pressurized gas source, and a conduit coupling the pressurized gas source to the sealing member.

Microfibers and nanofibers produced using any of the devices and methods described herein may be used in a variety of applications. Some general fields of use include, but are not limited to: food, materials, electrical, defense, tissue engineering, biotechnology, medical devices, energy, alternative energy (e.g., solar, wind, nuclear, and hydroelectric energy); therapeutic medicine, drug delivery (e.g., drug solubility improvement, drug encapsulation, etc.); textiles/fabrics, nonwoven materials, filtration (e.g., air, water, fuel, semiconductor, biomedical, etc.); automotive; sports; aeronautics; space; energy transmission; papers; substrates; hygiene; cosmetics; construction; apparel, packaging, geotextiles, thermal and acoustic insulation.

In some embodiments, microfibers and/or nanofibers may be formed from polyalkylene polymers (e.g., polyethylene, polypropylene, etc.). Polyalkylene microfibers and/or nanofibers may be used in a number of products and applications. Exemplary, non-limiting products and applications that may use polyalkylene microfibers and/or nanofibers include: nonwoven liquid barriers; surgical barriers that are gamma sterilizable; liquid filters; air filters; thermal bonding; food packaging (using e.g., high molecular weight polyethylene, “HMWPE”); medical device packaging (using e.g., HMWPE); moisture resistant building insulation (using e.g., HMWPE); breathable barrier fabrics (e.g., for apparel), and battery separators.

Some products that may be formed using microfibers and/or nanofibers include but are not limited to: filters using charged nanofiber and/or microfiber polymers to clean fluids; catalytic filters using ceramic nanofibers (“NF”); carbon nanotube (“CNT”) infused nanofibers for energy storage; CNT infused/coated NF for electromagnetic shielding; mixed micro and NF for filters and other applications; polyester infused into cotton for denim and other textiles; metallic nanoparticles or other antimicrobial materials infused onto/coated on NF for filters; wound dressings, cell growth substrates or scaffolds; battery separators; charged polymers or other materials for solar energy; NF for use in environmental clean-up; piezoelectric fibers; sutures; chemical sensors; textiles/fabrics that are water & stain resistant, odor resistant, insulating, self-cleaning, penetration resistant, anti-microbial, porous/breathing, tear resistant, and wear resistant; force energy absorbing for personal body protection armor; construction reinforcement materials (e.g., concrete and plastics); carbon fibers; fibers used to toughen outer skins for aerospace applications; tissue engineering substrates utilizing aligned or random fibers; tissue engineering Petri dishes with aligned or random nanofibers; filters used in pharmaceutical manufacturing; filters combining microfiber and nanofiber elements for deep filter functionality; hydrophobic materials such as textiles; selectively absorbent materials such as oil booms; continuous length nanofibers (aspect ratio of more than 1,000 to 1); paints/stains; building products that enhance durability, fire resistance, color retention, porosity, flexibility, anti-microbial, bug resistant, air tightness; adhesives; tapes; epoxies; glues; adsorptive materials; diaper media; mattress covers; acoustic materials; and liquid, gas, chemical, or air filters.

Fibers may be coated after formation. In one embodiment, microfibers and/or nanofibers may be coated with a polymeric or metal coating. Polymeric coatings may be formed by spray coating the produced fibers, or any other method known for forming polymeric coatings. Metal coatings may be formed using a metal deposition process (e.g., CVD).

Fibers may be formed from a solution or suspension of one or more polymer(s) in a solvent. Solvents that may be used include any solvents having a boiling point of less than about 200° C. and that dissolve the polymer(s).

Exemplary solvents that may be used include, but are not limited to, acetone, methanol, ethanol, isopropanol, n-propanol, n-butanol, dimethyl 1 sulfoxide (DMSO), dimethyl lacetamide (DMA), dimethylformamide (DMF), polyethylene glycol, tetrahydrofuran, ethyl acetate, acetonitrile, propylene carbonate, methyl ethyl ketone, water and mixtures thereof

The average diameter of the fibers is, in part, controlled by the concentration of the polymeric components in the solvent. In an embodiment the weight % of solids to solvent ranges from about 2% to about 30%. Compositions having more than 30% solids are, in some embodiments, too viscous for consistent centrifugal spinning. Compositions having less than 2% solids were generally found to be too dilute for fiber formulation.

The average diameter of the fibers may be controlled by controlling the viscosity of the composition. In an embodiment, the concentration of solids and/or the solvent used is selected to create a composition having a viscosity ranging from about 100 cP to about 10,000 cP. Compositions having a low viscosity lead to fibers having a small average diameter (e.g., between about 300 nm and 5 microns). Higher viscosity compositions lead to fibers having a larger average diameter (e.g., 10-20 microns). By selecting the appropriate viscosity or concentration of components in the composition, the average fiber diameter of the produced fibers can be controlled to range from 300 nm up to 20 microns.

In one embodiment, improved fiber production can be seen when the composition is filtered prior to placing the composition in the fiber producing device. Filtration is used to remove micro-gel and undissolved polymeric components in the composition. More consistent fiber diameters and morphology is obtained when the composition is filtered prior to use. In one embodiment, filtration is performed by passing the composition through a wire mesh having a microns rating of between about 2 microns to about 50 microns. Contaminants may also be removed by filtering the solvent before the polymeric components are dissolved in the solvent. In one embodiment, the solvent may be filtered prior to use by passing the solvent through a wire mesh having a micron rating of between about 2 microns to about 50 microns. In a preferred embodiment, the solvent is filtered prior to use and the composition, formed using the filtered solvent, is also filtered prior to use.

In an embodiment, the composition is conditioned prior to placing the composition in the fiber producing device. Conditioning is accomplished by heating the composition to a temperature that is substantially equal to the temperature used during centrifugal spinning of the composition (the “processing temperature”). This minimizes temperature changes to the composition during processing. If the temperature of the composition changes by a significant amount (e.g., plus/minus 5 degrees) the viscosity of the composition may change leading to fibers having unexpected average diameters. In an embodiment, the composition is held at the processing temperature for a time of about 30 minutes to about 5 hours prior to use. Typical processing temperatures used to produce fibers range from about 25° C. to about 100° C.

In order to ensure that the composition remains at the processing temperature during fiber production, the fiber producing device may be independently heated to a temperature that will maintain the temperature of the composition at the processing temperature. In some embodiments, the temperature of the fiber producing device may be different (e.g., higher) than the processing temperature to compensate for the cooling effect of the fiber producing device spinning at high rotational speeds.

The fiber producing device generally includes openings having a diameter ranging from about 100 microns to about 500 microns. The diameter of the openings, the viscosity of the composition, and the rotational speed of the fiber producing device, all contribute to determining the morphology and the size of the produced fibers. To adjust the morphology and/or size of the produced fibers, one or more of these parameters may be adjusted.

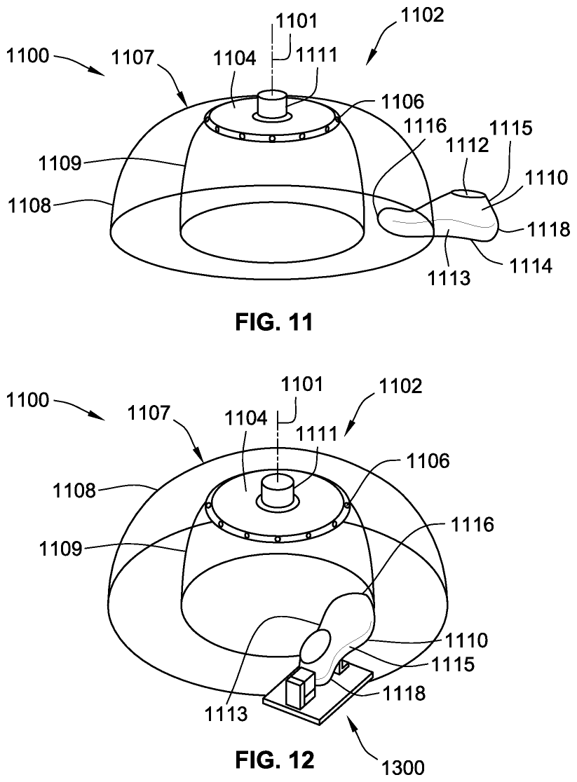

FIG. 11 illustrates an embodiment of a microfiber and/or nanofiber coating system 1100 coating an object 1110. The coating system 1100 includes a fiber producing device 1102. The fiber producing device 1102 has a body 1104 having a plurality of openings 1106. The body 1104 is configured to receive material to be produced into a fiber 1107. In use, the fiber producing device 1102 produces fibers 1107 between an outer and inner fiber veil 1108, 1109.

A driver is coupled to the body 1104. The driver can be coupled to a shaft 1111 of the body 1104 and can rotate the body 1104 about the axis of rotation 1101 via rotation of the shaft 1111, which causes fibers 1107 to be ejected from the openings 1106 of the fiber producing device 1102. A deposition system (see FIGS. 9-10) may direct fibers produced by the fiber producing device 1102 towards an object 1110 (e.g., an object 1110 in the shape of a human foot) disposed below the fiber producing device 1102. In use, the portion of the object 1110 that is placed between the outer and inner fiber veil 1108, 1109 will become at least partially coated by the fibers 1107 being produced by the fiber producing device 1102.

FIG. 12 illustrates another embodiment of a microfiber and/or nanofiber coating system 1100. The microfiber and/or nanofiber coating system 1100 includes a support 1300. The support 1300 holds the object 1110 to be coated by fibers 1107 during the coating process. The support 1300 allows for the object 1110 to move with respect to the fibers 1107 such that at least a portion of each of the exterior surfaces of the object 1110 are coated by fibers 1107 being produced by the fiber producing device 1102. In use, the body 1104 causes material in the body 1104 to be ejected through one or more openings 1106 to produce microfibers and/or nanofibers 1107 that are at least partially transferred to the object 1110 that is held on the support 1300.

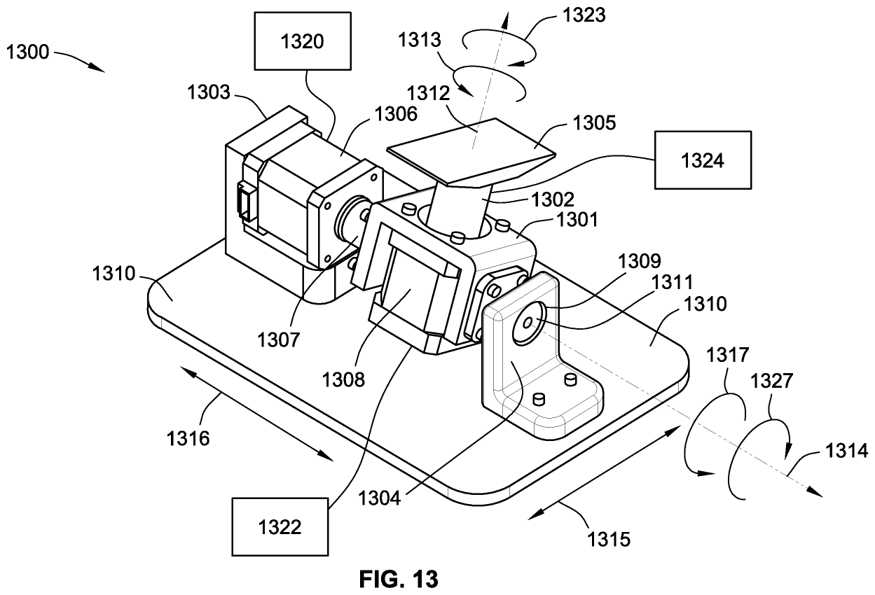

FIG. 13 illustrates an embodiment of a support 1300. The support 1300 has a base plate 1310. Coupled to the base plate 1310 is a first side bracket 1303 and a second side bracket 1304. The first side bracket 1303 secures a first or rotational motor 1306 having a rotational member 1307. A first end of the rotational member 1307 is coupled to the first motor 1306 and a second end of the rotational member 1307 is coupled to a first side of a support bracket 1301.

On the opposite side of the support bracket 1301 is coupling member 1311 that has a corresponding receiving aperture 1309 located in the second side bracket 1304. The receiving aperture 1309 will receive and provide support to the coupling member 1311 of the support bracket 1301, such that coupling member 1311 may freely rotate within the receiving aperture 1309 while the receiving aperture 1309 supports the support bracket 1309 via the coupling member 1311.

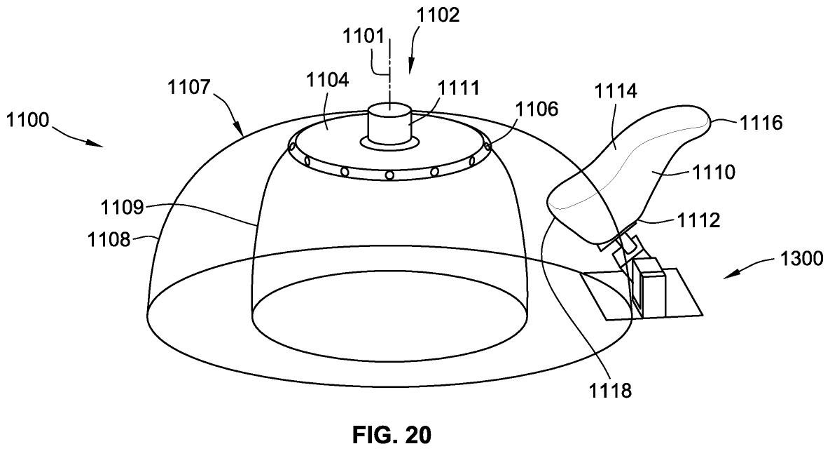

In addition, the support 1300 has a second or rotational motor 1308 that is coupled to and supported by the support bracket 1301. The second motor 1308 is coupled to a first end of a support pole 1302 and a second end of the support pole 1302 terminates into a platform 1305 that can be used to secure an object 1110 to be coated by fibers 1107 produced by a microfiber and/or nanofiber coating system 1100 (see FIG. 20).

When the first motor 1306 is activated it can rotate the rotational member 1307 about the first axis of rotation 1314 in a first or second direction 1317, 1327, such that the rotation of the rotational member 1307 about the first axis of rotation 1314 also rotates the support bracket 1301 about the first axis of rotation 1314, which in turn rotates the platform 1305 and/or an object 1110 about the first axis of rotation 1314. Thus, a user can control the rotation of the platform 1305 about the first axis of rotation 1314 via activation of the first motor 1306 to rotate the rotational member 1307 about the first axis of rotation 1314 in the first or second direction 1317, 1327.

When the second motor 1308 is activated it can rotate the support pole 1302 about a second axis of rotation 1312 in a first or second direction 1313, 1323, such that the platform 1305 also rotates about the second axis of rotation 1312 in the first or second direction 1313, 1323. Thus, a user can control the rotation of the platform 1305 and/or an object 1110 about the second axis of rotation 1312 via activating the second motor 1306 to rotate the support pole 1302 about the second axis of rotation 1312 in the first or second direction 1313, 1323.

In one embodiment of the support 1300, the first motor 1306 may be controlled by a first controller 1320 and the second motor 1308 may be controlled by a second controller 1322. The first and/or second controllers 1320, 1322 may include a memory including instructions and a processor coupled to the memory that, when executing the instructions, may cause the first and/or second motor 1306, 1308 to execute a step or series of steps to take an action on the support 1300, such as, but not limited to supplying an electrical current to the support 1300, moving the position of the support 1300, and/or moving a portion 1300 of the support 1300.

In one embodiment, the first controller 1320 can have memory having executable instructions that when executed by the processor cause the processor to effectuate operations to active the first motor 1306 to complete a step or a series of steps to take action on the support 1300, such as, but not limited to, supplying an electrical current to the support 1300, moving the position of the support 1300, and/or moving a portion of the support 1300 and the second controller 1322 can have memory having executable instructions that when executed by the processor to effectuate operations to activate the second motor 1308 to complete a step or series of steps to take action on the support 1300, such as, but not limited, supplying an electrical current to the support 1300, moving the position of the entire support 1300, and/or moving a portion 1300 of the support 1300.

In another embodiment, the first and second motor 1306, 1308 may be controlled by a single controller that has a memory coupled to a processor that has executable instructions that when executed by the processor effectuates operations to active the first and/or second motor 1306, 1308 to complete a step or series of steps to take action on the support 1300, such as, but not limited to, supplying an electrical current to the support 1399, moving the position of the entire support 1300, and/or moving a portion of the support 1300.

As will also be understood, the first motor 1306 and the second motor 1308 can be activated separately or in concert with one another. For example, the first motor 1306 can be activated to rotate the platform 1305 about the first axis of rotation 1314 while the second motor 1308 is inactive and vice versa. On the other hand, the first motor 1306 can be used in concert with the second motor 1308 such that the platform can be rotated about the first axis of rotation 1314 via the activation of the first motor 1306 at the same time the platform 1305 is rotated about the second axis of rotation 1312 via activation of the second motor 1308.

Additionally, the baseplate 1310 of the support 1300 may be coupled to the microfiber and/or nanofiber coating system 1100 in order to allow movement of the support 1300 with or relative to the coating system 1100, as indicated by numerals 1315 and 1316.

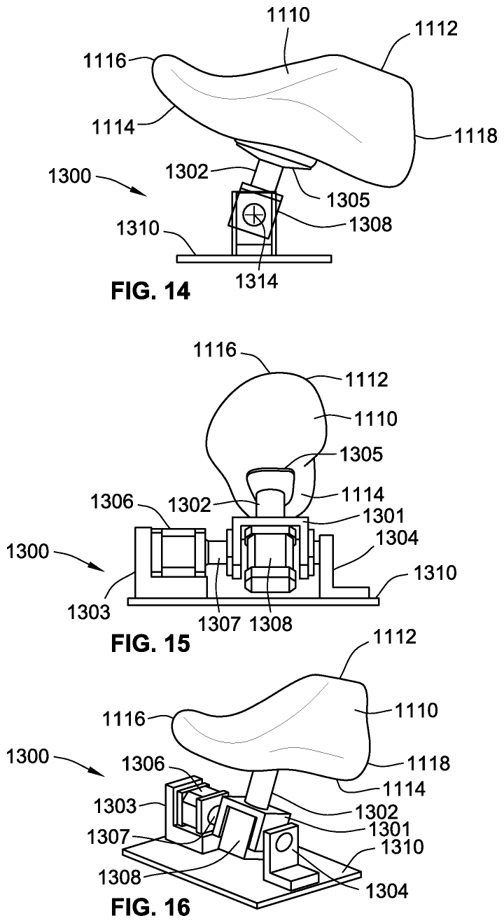

FIGS. 14-16 illustrate an embodiment of the positioning of an object 1110 being held by a support 1300. The object 1110 being held on the platform 1305 of the support 1300 takes the form of a human foot. The object 1110 has a top portion 1112 and a bottom portion 1114 as well as a front portion 1116 and a rear portion 1118. In the illustrated embodiment, the object 1110 is coupled to the platform 1305 along a small area of the bottom portion 1114 of the object 1110. As will be understood, by securing the object 1110 to the platform 1305 by its bottom portion 1114 it leaves the top portion 1112 of the object 1110 exposed to be coated by fibers 1107 being produced by a microfiber and/or nanofiber coating system 1100.

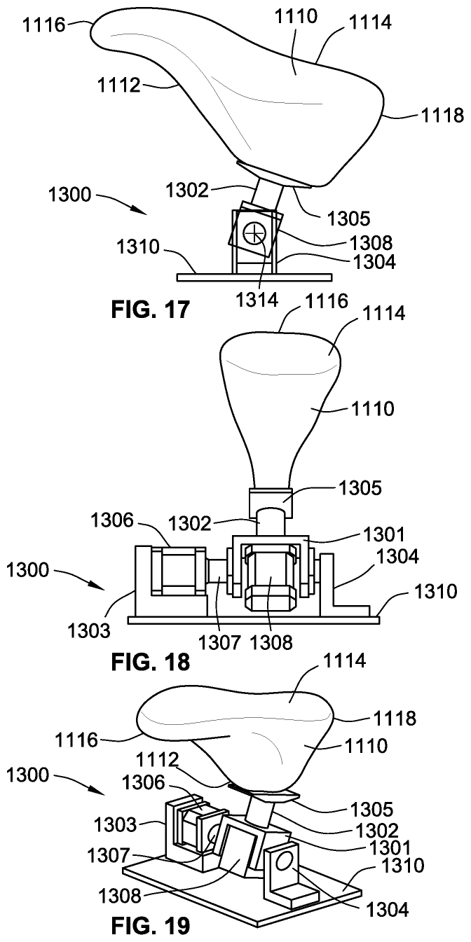

FIGS. 17-20 illustrate an embodiment of the positioning of an object 1110 being held by a support 1300. The object 1110 is in the form of a human foot. The object 1110 has a top portion 1112 and a bottom portion 1114 as well as a front portion 1116 and a rear portion 1118. In the illustrated embodiment the object 1110 is coupled to the platform 1305 along a small area of the top portion 1112 of the object 1110. As will be understood, by securing the object 1110 to the platform 1305 by its top portion 1112 it leaves the bottom portion 1114 of the object 1110 exposed to be coated by fibers 1107 being produced by a microfiber and/or nanofiber coating system 1100.

Additional features of the support 1300 depicted in FIG. 13 may include that the hardware of the support 1300 is 3D printed, but the base plate 1310 may be made from G10 or a metal plate to provide some eight and prevent tipping of the support 1300.

In yet another embodiment, a forming wire may be used to move the support 1300 along a machining direction, such as the directions indicated by arrows 1315, 1316

In another embodiment the support 1300 can charge the object 1110 with an electrostatic generator 1324. According to one embodiment, the electrostatic generator 1324 may charge the object 1110 up to 10 kV.

In still yet another embodiment, if the object 1110 is serving as a mold to be coated then the object 1110 may be 3D printed using a conductive material.

Another embodiment may include a cover on or near the support 1300 that prevents the first and/or second motor 1306, 1308 from being coated by any fibers 1107 being produced by a microfiber and/or nanofiber coating system 1100.

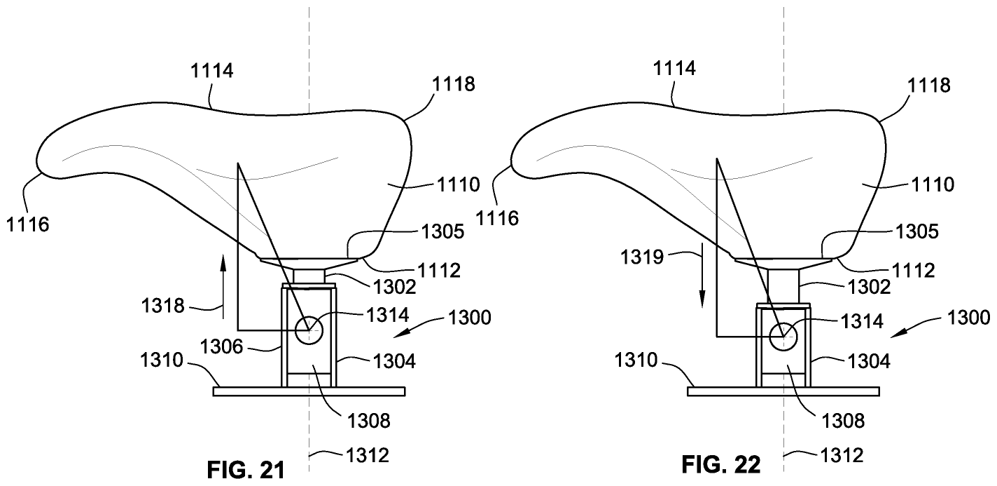

FIGS. 21-22 depict an embodiment of a support 1300. The support 1300 has a first and second motor 1306, 1308. The second motor 1308 is coupled to a first end of a support pole 1302 and the second end of the support pole 1302 terminates in a platform 1305. The platform 1305 secures and holds an object 1110 while the object 1110 is coated with fibers 1107 produced by a microfiber and/or nanofiber coating system 1100.

The second motor 1308 can rotate the platform 1305 about a second axis 1312 (see FIG. 13) of the support 1300, such that the second motor 1308 is capable of rotating the platform 1305 360° about the second axis 1312 in a first and second direction 1313, 1323. In addition, in the illustrated embodiment the second motor 1308 can also actuate the support pole 1302 from a partially retracted state, as illustrated in FIG. 21, into a partially extended state as illustrated in FIG. 22, such that the support pole 1302 extends in a linear direction away from the base plate 1310 of the support 1300.

As will be understood, the actuation of the support pole 1302 from the partially retracted state into the partially extended state also causes the platform 1305 to move linearly parallel to axis 1312 in a direction generally away from the base plate 1310 of the support 1300, which in turn causes the object 1110 coupled to the platform 1305 to move in a linear direction away from the base plate 1310 of the support 1300. Thus, a user can control the linear movement of the object 1110 along axis 1312 via actuating the support pole 1302 by the second motor 1308, such that the second motor 1308 actuates the support pole 1302 from a partially retracted state into a partially extended state and vice versa.

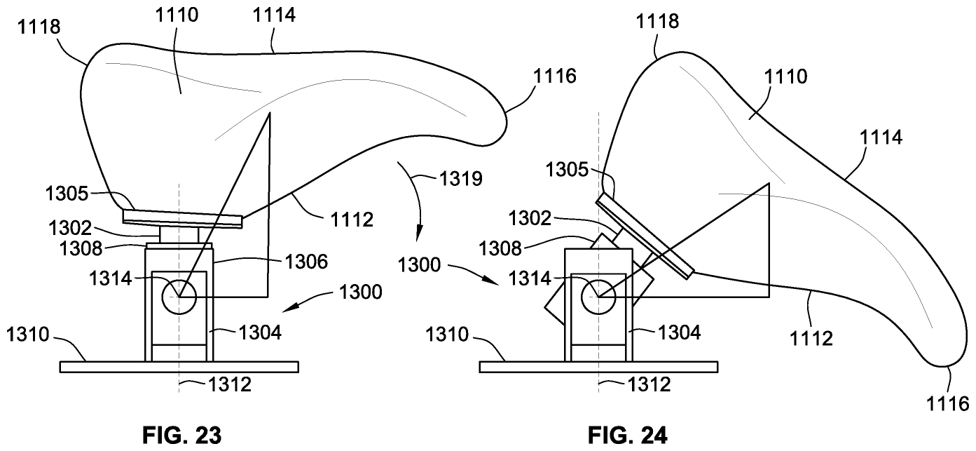

FIGS. 23-24 depict a first and second position of an embodiment of a support 1300. The support 1300 has a first and second motor 1306, 1308. The second motor 1308 is coupled to a first end of a support pole 1302 and the second end of the support pole 1302 terminates in a platform 1305. The platform 1305 secures and holds an object 1110 while the object 1110 is coated with fibers 1107 produced by a microfiber and/or nanofiber coating system 1100. The first motor 1306 can rotate the platform 1305 about a first axis of rotation 1314 in a first or second direction 1317, 1327 (see FIG. 13).

FIG. 23 illustrates the support 1300 in a first position where the platform 1305 and the bottom portion 1112 of the object 1110 are perpendicular to the base plate 1310 of the support 1300. However, as indicated by arrow 1319 in FIG. 23, the first motor 1306 can be activated to rotate the platform 1305 and object 1110 about the first axis of rotation 1314 in the second direction 1327 (see FIG. 13) to transition the support 1300 from the first position to a second position as is illustrated in FIG. 24.

FIG. 24 illustrates the second position of the support 1300 after the first motor 1306 has been activated to rotate the platform 1305 and the object 1110 about the first axis of rotation 1314 in the second direction 1327 (see FIG. 13). In the second position, the platform 1305 and the object 1110 are no longer perpendicular to the base plate 1310 of the support 1300 (e.g. illustrated by support pole 1302 and axis 1312). Rather, the platform 1305 and the object 1110 have been rotated about the first axis of rotation 1314 ˜45° in the second direction 1327 (see FIG. 13).

As will be understood, the first motor 1306 can also be activated to rotate the platform 1305 and/or object 1110 about the first axis of rotation 1314 in the first direction 1317 in a similar manner.

Further, as will also be understood, the first motor 1306 is not limited to rotating the platform 1305 and/or object 1110 ˜45°. Rather, a user may program the first motor 1306 to rotate the platform 1305 and/or object 1110 about the first axis of rotation 1314 in the first or second direction 1317, 1327 by any amount desired by the user.

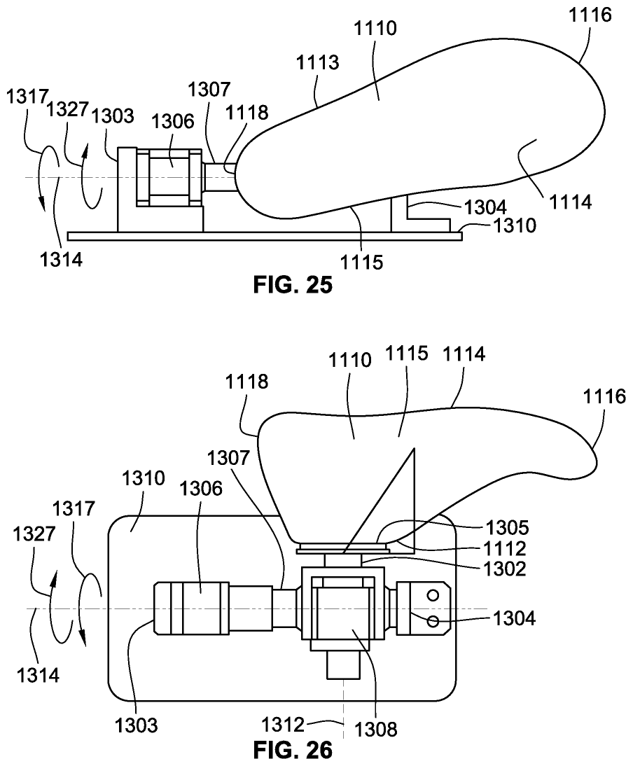

For example, FIGS. 25-26 illustrate a first and second position of an embodiment of a support 1300 holding an object 1110 in the form of a human foot on the platform 1305 of the support 1300.

FIG. 25 illustrates the support 1300 holding the object 1110 on the platform 1305 in a first position. In the first position the first motor 1306 has been activated such that the platform 1305 and the object 1110 have been rotated ˜90° about the first axis of rotation 1314 in the first direction 1317, such that the platform 1305 is perpendicular to the base plate 1310 of the support 1300. As is illustrated, in the first position a first side 1113 of the object 1110 is exposed, which allows for the first side 1113 of the object 1110 to be coated by any fibers 1307 that may be being produced by a microfiber and/or nanofiber coating system 1100 (see FIGS. 11-12) that the support 1300 may be being used with.

FIG. 26 illustrates the support 1300 holding the object 1110 on its platform 1305 in a second position after the first motor 1306 has been activated to rotate the platform 1305 and the object 1110 ˜180° about the first axis of rotation 1314 in the second direction 1327, such that the platform 1305 and the object 1110 have also been rotated ˜180° about the first axis of rotation 1314 in the second direction 1327, such that the platform 1305 is again perpendicular to the base plate 1310 of the support 1300. As illustrated, in the second position a second side 1115 of the object 1110 is exposed, which allows for the second side 1115 of the object 1110 to be coated by any fibers 1307 that may be being produced by to a microfiber and/or nanofiber coating system 1100 (see FIGS. 11-12) that the support 1300 may be being used with.

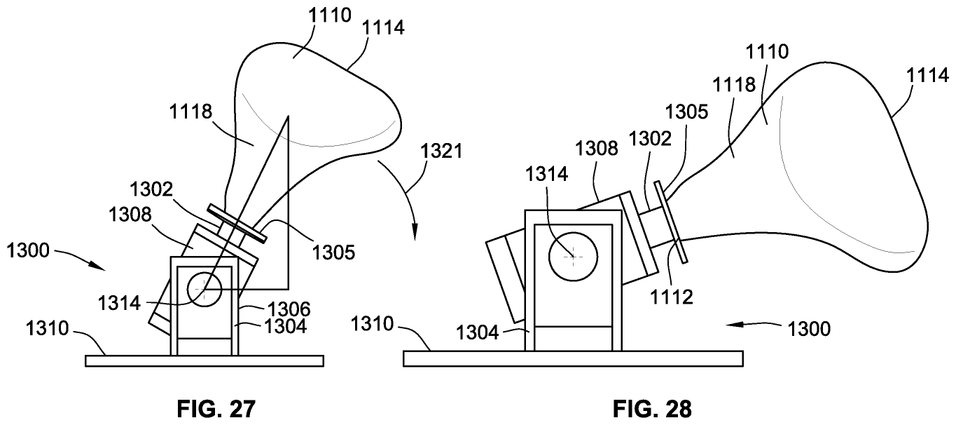

FIGS. 27-28 illustrate a first and second position of an embodiment of a support 1300 holding an object 1110 in the form of a human foot on a platform 1305 of the support 1300.

FIG. 27 illustrates the support 1300 holding the object 1110 on the platform 1305 in a first position. In the first position the first motor 1306 has been activated to rotate the platform 1305 and the object 1110 about the first axis of rotation 1314 ˜15° in the second direction 1327 relative to the base plate 1310 of the support 1300.

FIG. 28 illustrated the support 1300 holding the object 1110 on the platform 1305 in a second position. To transfer the support 1300 from the first position (see FIG. 27) to the second position the first motor 1306 will be activated to rotate the platform 1305 and the object 1110 about the first axis of rotation 1314 ˜15° in the second direction 1327. The transition of the support 1300 from the first position (see FIG. 27) to the second position causes the platform 1305 and the object 1110 to have been rotated about the first axis of rotation 1314 ˜60° 1306 relative to the base plate 1310 of the support 1300.

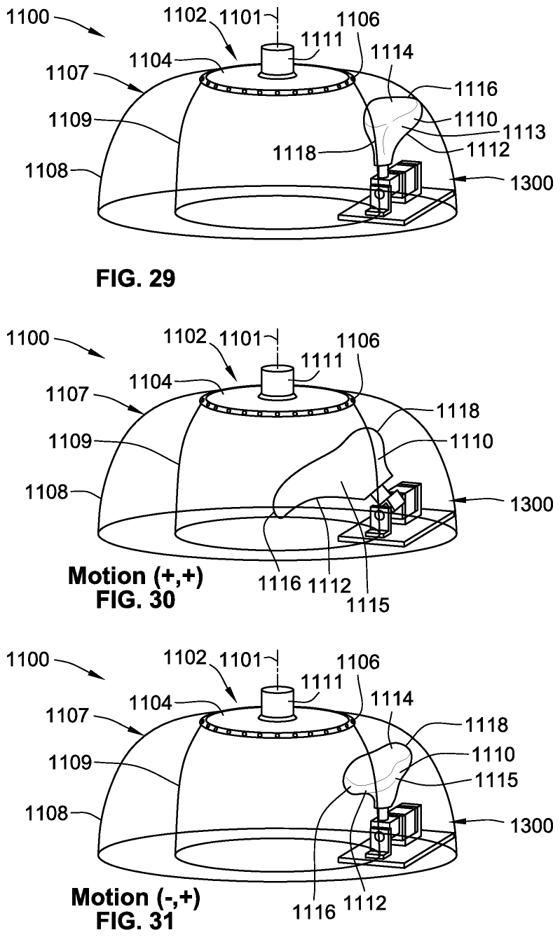

FIGS. 29-37 depict an example of a series movements that the support 1300 may use in order to substantially fully coat an object 1110 (e.g., a foot shaped mold) with fibers 1107 being produced by an embodiment of a microfiber and/or nanofiber coating system 1100. In the embodiment illustrated in FIGS. 29-37 the movement of the first or tilt motor 1306 and the second or rotational motor 1308 is indicated by (+),(−), and (0).

For the tilt motor 1306 the (+) indicates that the tilt motor 1306 is activated to rotate about the first axis of rotation 1314 in the first direction 1317 (see FIG. 13), which will tilt the platform 1305 and the object 1110 in the first direction 1317 about the first axis of rotation 1314 relative to the position of the platform 1305 and object 1110 in the previous step.

For the tilt motor 1306 the (−) indicates that the tilt motor 1306 is activated to rotate about the first axis of rotation 1314 in the second direction 1327 (see FIG. 13) to shift the platform 1305 and the object 1110 in the second direction 1327 about the first axis of rotation 1314 relative to the position of the platform 1305 and object 1110 in the previous step.

Finally, for the tilt motor 1306 the (0) indicates that the tilt motor 1306 is not activated during that step and that the platform 1305 and object 1110 will not be tilted about the first axis of rotation 1314 during that step.

For the rotational motor 1308 the (+) indicates that the rotational motor 1308 is activated to rotate about the second axis of rotation 1313 in the first direction 1313 (see FIG. 13), which will rotate the platform 1305 and the object 1110 in the first direction 1313 about the second axis of rotation 1313 relative to the position of the platform 1305 and object 1110 in the previous step.

For the rotational motor 1308 (−) indicates that the rotational motor 1308 is activated to rotate about the second axis of rotation 1313 in the second direction 1323 (see FIG. 13), which will rotate the platform 1305 and object 1110 in the second direction 1323 about the second axis of rotation 1313 relative to the position of the platform 1305 and object 1110 in the previous step.

Finally, for the rotational motor 1308 the (0) indicates that the rotational motor 1308 is not activated during that step and that the platform 1305 and object 1110 will not be rotated about the second axis of rotation 1313 during that step.

FIG. 29 illustrates the first or starting position of the support 1300 of the illustrated embodiment. In the first or starting position a user or robot will couple the top portion 1112 of the object 1110 to the platform 1305 of the support 1300. The object 1110 will remain coupled to the platform 1305 while the tilt motor 1306 and the rotational motor 1308 of the support 1300 are activated according to a sequence that will manipulate the position of the object 1110, such that the object 1110 will be substantially fully coated by the fibers 1107 being produced by the microfiber and/or nanofiber coating system 1100.

FIG. 30 illustrates a second position of the support 1300 according to the illustrated embodiment. To transfer the support 1300 from the first position to the second position the tilt motor 1306 is activated to tilt the platform 1305 and the object 1110 ˜45° about the first axis of rotation 1314 in the first direction 1317 (+) relative to the position of the platform 1305 and the object 1110 in the first position (see FIG. 29), while the rotational motor 1308 is activated to rotate the platform 1305 and the object 1110 ˜90° about the second axis of rotation 1312 in the first direction 1313(+) relative to the position of the platform 1305 and the object 1110 in the first position (see FIG. 29). This movement is indicated by motion (+,+).

FIG. 31 illustrates a third position of the support 1300 according to the illustrated embodiment. To transfer the support 1300 from the second position to the third position the tilt motor 1306 is activated to tilt the platform 1305 and the object 1110 ˜45° about the first axis of rotation 1314 in the second direction 1327 (−) (see FIG. 13) relative to the position of the platform 1305 and the object 1110 in the second position (see FIG. 30), while the rotational motor 1308 is activated to rotate the platform 1305 and the object 1110 ˜90° about the second axis of rotation 1312 in the first direction 1313 (+) relative to the position of the platform 1305 and the object 1110 in the second position (see FIG. 30). This movement is indicated by motion (−,+).

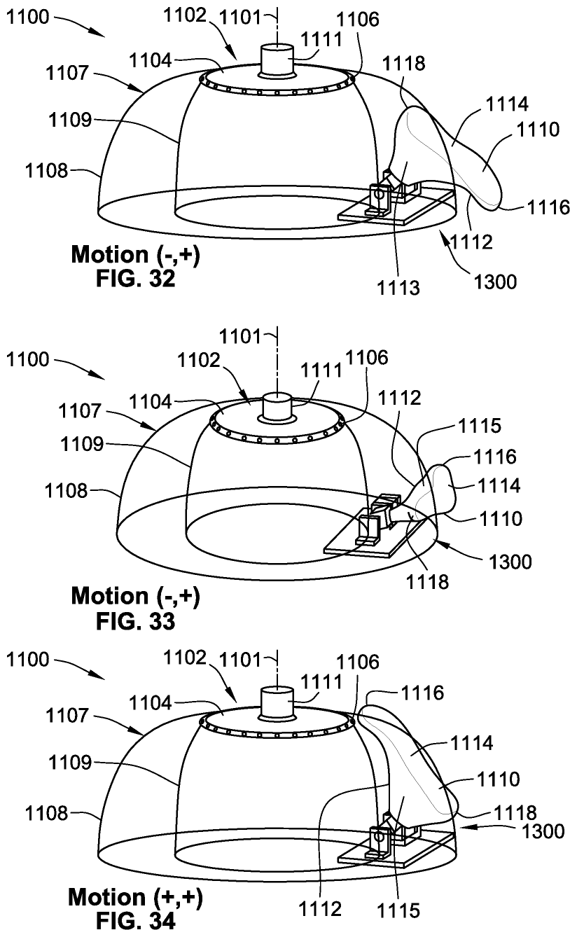

FIG. 32 illustrates a fourth position of the support 1300 according to the illustrated embodiment. To transfer the support 1300 from the third position to the fourth position the tilt motor 1306 is activated to tilt the platform 1305 and the object 1110 ˜45° about the first axis of rotation 1314 in the second direction 1327 (−) (see FIG. 13) relative to the position of the platform 1305 and the object 1110 in the third position (see FIG. 31), while the rotational motor 1308 is activated to rotate the platform 1305 and the object 1110 ˜90° about the second axis of rotation 1312 in the first direction 1313 (+) (see FIG. 13) relative to the position of the platform 1305 and the object 1110 in the third position (see FIG. 31). This movement is indicted by motion (−,+).

FIG. 33 illustrates a fifth position of the support 1300 according to the illustrated embodiment. To transfer the support 1300 from the fourth position to the fifth position the tilt motor 1306 is activated to tilt the platform 1305 and the object 1110 ˜45° about the first axis of rotation 1314 in the second direction 1327 (−) (see FIG. 13) relative to the position of the platform 1305 and the object 1110 in the fourth position (see FIG. 32), while the rotational motor 1308 is activated to rotate the platform 1305 and the object 1110 ˜90° about the second axis of rotation 1312 in the first direction 1313 (+) (see FIG. 13) relative to the position of the platform 1305 and the object 1110 in the fourth position (see FIG. 32). This movement is indicated by (−,+).

FIG. 34 illustrates a sixth position of the support 1300 according to the illustrated embodiment. To transfer the support 1300 from the fifth positon to the sixth position the tilt motor 1306 is activated to tilt the platform 1305 and the object 1110 ˜45° about the first axis of rotation 1314 in the first direction 1317 (+) (see FIG. 13) relative to the position of the platform 1305 and the object 1110 in the fifth position (see FIG. 33), while the rotational motor 1308 is activated to rotate the platform 1305 and the object 1110 ˜90° about the second axis of rotation 1312 in the first direction 1313 (+) (see FIG. 13) relative to the position of the platform 1305 and the object 1110 in the fifth positon (see FIG. 33). This motion is indicated by (+,+).

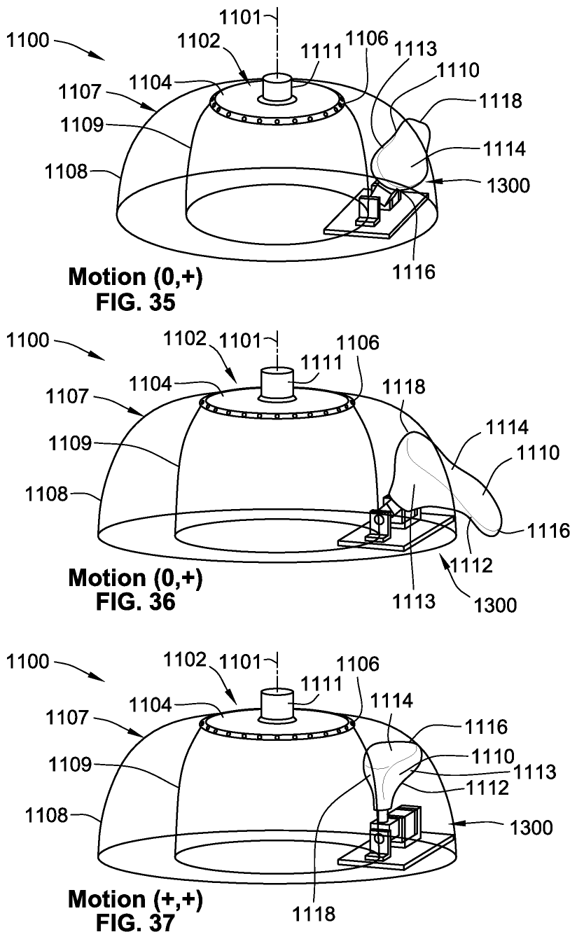

FIG. 35 illustrates a seventh position of the support 1300 according to the illustrated embodiment. To transfer the support 1300 from the sixth positon to the seventh position the tilt motor 1306 is not activated and the platform 1305 and the object 1110 are not rotated about the first axis of rotation 1314 in this step (0) (see FIG. 13), while the rotational motor 1308 is activated to rotate the platform 1305 and the object 1110 ˜90° about the second axis of rotation 1312 in the first direction 1313 (+) (see FIG. 13) relative to the position of the platform 1305 and the object 1110 in the sixth position (see FIG. 34). This motion is indicated by (0,+).

FIG. 36 illustrates an eight position of the support 1300 according to the illustrated embodiment. To transfer the support 1300 from the seventh position to the eighth position the tilt motor 1306 is again not activated and the platform 1305 and the object 1110 are not rotated about the first axis of rotation 1314 in this step (0) (see FIG. 13), while the rotational motor 1308 is activated to rotate the platform 1305 and the object 1110 ˜90° about the second axis of rotation 1312 in the first direction 1313 (+) (see FIG. 13) relative to the position of the platform 1305 and the object 1110 in the sixth position (see FIG. 35). This motion is indicated by (0,+).

FIG. 37 illustrates a ninth position of the support 1300 according to the illustrated embodiment. To transfer the support 1300 from the eight position to the ninth position the tilt motor 1306 is activated to tilt the platform 1305 and the object 1110 ˜45° about the first axis of rotation 1314 in the first direction 1317 (+) (see FIG. 13) relative to the position of the platform 1305 and the object 1110 in the eighth position (see FIG. 36), while the rotational motor 1308 is activated to rotate the platform 1305 and the object 1110 ˜90° about the second axis of rotation 1312 in the first direction 1313 (+) (see FIG. 13) relative to the position of the platform 1305 and the object 1110 in the eight position (see FIG. 36). This motion is indicated by (+,+).

In the ninth position, the object 1110 has been manipulated by the support 1300, such that the object 1110 has been sufficiently coated by fibers 1107 from the microfiber and/or nanofiber coating system 1100. In addition, the ninth position returns the support 1300 to the first or starting position (see FIG. 29), such that a user or robot can remove the object 1110 that has been sufficiently coated with fibers 1107 from the platform 1305 of the support 1300 and the coated object 1110 with an uncoated object 1110 where the coating process can begin again on the uncoated object 1110.

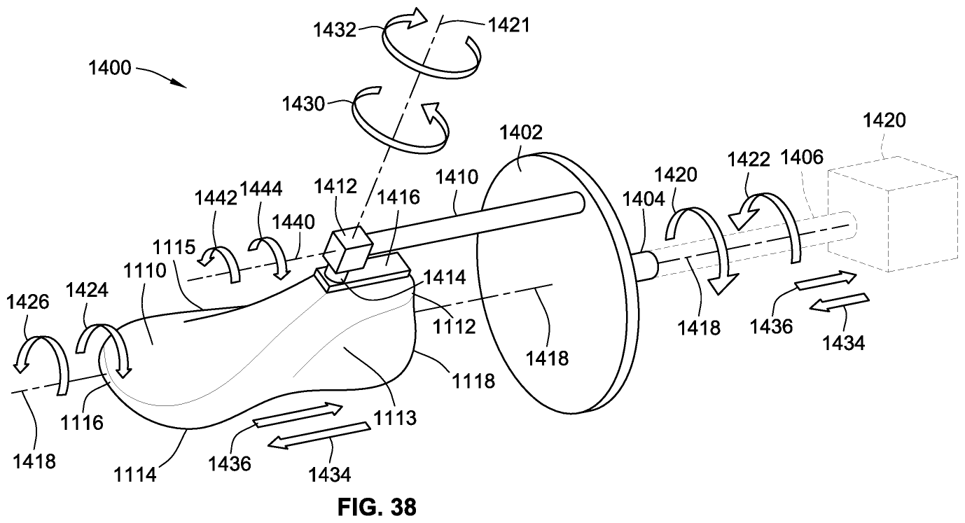

FIG. 38 depicts another embodiment of a support 1400 according to one aspect of the present application. The support 1400 can hold an object 1110 to be coated by a microfiber and/or nanofiber coating system 1100 (see FIGS. 11-12). The support 1400 includes a base plate 1402. On a first side of the base plate 1402 is a coupling member 1404 that is coupled to a first end of a coupling means 1406, which could take the form of a shaft. The second end of the coupling means 1406 is moveably coupled to a first motor 1420.

The second side of the base plate 1402 is coupled to a first end of a support pipe 1410, which may be hollow or solid. The second end of the support pipe 1410 is coupled to a first side of a second motor 1412. A second side of the second motor 1412 is rotationally coupled to a first end of a coupling extension 1414. The second end of the coupling extension 1414 is coupled to a platform 1416 that holds an object 1110 to be coated by fibers 1107 produced by a microfiber and/or nanofiber coating system 1100 (see FIGS. 11-12).

According to one embodiment, when the first motor 1420 is activated it rotates the coupling means 1406 about a first axis of rotation 1418 in a first or second direction 1420, 1422. The rotation of the coupling means 1406 also causes the base plate 1402 to rotate about the first axis of rotation 1418 in the same first or second direction 1420, 1422 as the coupling means 1406. The rotation of the base plate 1402 then causes the support pipe 1410 to rotate along a circular path around the first axis of rotation 1418. The rotation of the support pipe 1410 also causes the platform 1416 to rotate around the same circular path as the support pipe 1410, which in turn causes the object 1110 being held by the platform 1416 to rotate around the circular path in the corresponding first or second direction 1424, 1426 that corresponds with the rotation of the coupling means 1406 in the first or second direction 1420, 1422 that is controlled by the activation of the first motor 1420.

As will be understood, the activation of the first motor 1420 to rotate the coupling means 1406 about the first axis of rotation 1418 in the first direction 1420 will cause the object 1110 to rotate around the circular path in a first direction 1424 and the activation of the first motor 1420 to rotate the coupling means 1406 about the first axis of rotation 1418 in the second direction 1422 will cause the object 1110 to rotate around the circular path in a second direction 1426.

Therefore, a user can program the rotation of the object 1110 around the circular path in the first or second direction 1424, 1426 via activating the first motor 1420 to rotate the coupling means 1406 about the first axis of rotation 1418 in the corresponding first or second direction 1424, 1426.

According to another embodiment, when the second motor 1412 is activated the coupling extension 1414 is rotated about a second axis of rotation 1421 in a first or a second direction 1430, 1432. The rotation of the coupling extension 1414 about the second axis of rotation 1421 in the first or second direction 1430, 1432 will also rotate the platform 1416 coupled to the second end of the coupling extension 1414 about the second axis of rotation 1421 in the same first or second direction 1430, 1432 as the coupling extension 1414 is rotated. Further, as the object 1110 is coupled to the platform 1416 the rotation of the platform 1416 also causes the object 1110 to rotate about the second axis of rotation 1421 in the same first or second direction 1430, 1432 as the platform 1416 that is holding the object 1110.

As will be understood, the rotation of the object 1110 about the second axis of rotation 1421 in the first or second direction 1430, 1432 can be controlled by activating the second motor 1412 to rotate the coupling extension 1414 in either the first or second direction 1430, 1432 about the second axis of rotation 1421.

In another embodiment, the second motor 1412 or a third motor can be activated such that the second motor 1412 rotates about a third axis of rotation 1440 created by the support pipe 1410 in a first or second direction 1442, 1444.

As will be understood, the rotation of the second motor 1412 about the third axis of rotation 1440 in the first or second direction 1442, 1444 will also rotate the coupling extension 1414 and the platform 1416 about the third axis of rotation 1440 in the same first or second direction 1442, 1444. Further, as the object 1110 is being held by the platform 1416 of the support 1400, the rotation of the platform 1416 about the third axis of rotation 1440 will also causes the object 1110 to rotate about the third axis of rotation 1440 in a circular path in the same first or second direction 1442, 1444 as the coupling extension 1414 and platform 1416 that is holding the object 1110 to the support 1300.

Therefore, as will be understood, the rotation of the object 1110 about the third axis of rotation 1440 in the first or second direction 1442, 1444 can be controlled by activating the second motor 1412 to rotate about the support pipe 1410, such that the second motor 1414 rotates about the third axis of rotation 1440 in either the first or second direction 1442, 1444.

Additionally, in one embodiment, the entire support 1400 may be moved into and out of the field of fibers 1107 produced by a microfiber and/or nanofiber coating system 1100 (see FIGS. 11-12) by activating the first motor 1420 or an independent motor to at least partially extend or at least partially retract the coupling means 1406 in a first or second linear direction 1434, 1436 along the first axis of rotation 1418. As the coupling means 1406 is coupled to the coupling member 1404 of the base plate 1402 the partial extension or retraction of the coupling means 1406 in the first or second linear direction 1434, 1436 along the first axis of rotation 1418 will also cause the base plate 1402, along with the rest of the support 1400, which is supported by the base plate 1402, to move in the same first or second linear direction 1434, 1436 along the first axis of rotation 1418 as the coupling means 1406.

Therefore, the support 1400, as well as the object 1110 being held on by the platform 1416 of the support 1400, can be moved in the first or second linear direction 1434, 1436 along first axis of rotation 1418 by at least partially extending or at least partially retracting the coupling means 1406 in the first or second linear direction 1434, 1436 along the first axis of rotation 1418 via activation of the first motor 1420.

Further, in another embodiment, the supports 1300, 1400 may be disposed on a rail or some other support that allows a controlled translation of the support 1400 into and out of the fiber field in the first or second linear direction 1434, 1436 or in any other direction desired by the user.

In some embodiment, the system may also include a fiber recycling system coupled to the deposition system, wherein fibers 1107 that are not deposited onto the object 1110 during use are collected by the fiber recycling system and returned to the deposition system. In some embodiments, the system further includes a transfer system, wherein the transfer system moves one or more objects 1110 through the deposition system.

It should be understood that any object 1110 can be coated with fibers 1107 using the above described system 1100 and methods. The system 1100 and method, however, are particularly suitable for forming clothing items and or shoes.

In some embodiments, the object 1110 will take the shape of a portion of a human body or a body part. For example, the object 1110 may be in the shape of: a foot; a hand; a head; a torso; or a waist with one or two legs joined to the waist. Objects 1110 in the shape of a body part or portion can be used to make shoes and clothing items such as: hats; masks; shirts; coats; bras; undergarments; hosiery; gloves; mittens; pants; shorts; high grip/soft hand products; sports gloves (golf, football, soccer, baseball batting gloves, motorsports racing gloves); shoe insoles; socks; bra cups; denim wear; waterproof breathables laminated to denim and jeans for both casual wear and work wear.

Fibers may be produced from either a polymer melt or a solution of a polymer in a suitable solvent. Exemplary polymer classes that are particularly useful for manufacturing shoes or clothing items include polyolefins, polyimides, polyamides, polyurethanes, and fluoropolymers. Some specific polymers that may be used include: polytetrafluoroethylene (PTFE); thermoplastic polyurethane (TPU); polyurethane (PU), cellulose acetate (CA), polyvinylidene difluoride (PVDF), polyamide 6 (PA6), polyamide 6,6 (PA66), polyethylene terephtlmlate (PET), perfluoroalkoy alkanes (PFA), polypropene (PP), polylactic acid (PLA), polycaprolactone (PCL), polyphenylene sulfide (PPS), and polyacrylonitrile (PAN).

A fiber producing composition may include one or more additives which: increase the hydrophobicity of the fibers; increase the alcohol resistance of the fibers; increase the chemical resistance of the fibers, or increase the strength of the fibers. Additives may be polymers, an oligomer, a small organic additive, or a non-polymeric additive mixed with a polymer carrier (a masterbatch). Polymeric additives may be hydrophobic to increase the water resistance of the shoe or clothing article. Exemplary hydrophobic additives include PVDF, Teflon (PTFE) and other fluorinated polymers, and 3M® Dynamar® Polymer Processing Additives (PPAs). Masterbatch compositions may be used, including, but not limited to, the following compositions: Hydrepel A203 from Polyvel and additives from Techmer PM (described in EP 2446075 A2). An exemplary small molecule/oligomeric additive includes Fluoroguard® from 3M.

In some embodiments, a surface treatment may be applied to the fiber coated object to: increase the hydrophobicity of the fibers; increase the alcohol resistance of the fibers; increase the chemical resistance of the fibers, or increase the strength of the fibers hydrophobicity. Methods of applying a surface treatment to the fibers include radiation techniques. Exemplary radiation techniques include, but are not limited to: plasma treatment (with specific gases) as discussed in WO 2000/014323A1 and http://arxiv.org/ftp/arxiv/papers/0801/0801.3727.pdf. Other techniques and coating materials include: coating technology from http://www.sigmalabs.com/technologies/; DryWired® Textile Shield; Oleophobol® from Huntsman LLC (also in WO 2014/116941 A1): Hydrofobic Extreme by http://www.nanomembrane.cz/; and fluoroalkyl acrylate copolymers (U.S. Pat. No. 8,088,445).

Additives and/or surface coatings may be used for specialty clothing items such as: odor resistant nanofiber membranes: antibacterial/antimicrobial materials (e.g., breathable nanofiber membranes processed with antibacterial additives to utilize the surface area of the fibers to deliver the antibacterial/microbial performance or nanofiber membranes spun from chemically enhanced polymers); chemical and biological protection (e.g., breathable fabrics from nanofibers with active protective agents disbursed on the surface); conductive fabrics derived from nanofiber materials to provide flexible conductive pathways to power electronics; wearable electronics and light emitting clothing; workwear; antistatic waterproof breathable membranes; and chemical protecting waterproof breathable membranes for pest control and other work environments.

The production of clothing items or shoes may be accomplished using a number of techniques. In one embodiment, fibers are used to form a coating around a 3D mold (as demonstrated on the foot mold). The fiber coating may be a single layer of nanofibers or multiple layers of nanofiber including multiple layers of different materials. The mold may be completely encapsulated or partially coated (as is the case with a seamless upper on a shoe). The mold may be a rotating 3D structure or a 3D structure formed in a moving belt or a stationary 3D structure. In the case of the stationary structure the position of the fiber producing device 1102 may move during the deposition. Regardless of the deposition methods, the nanofiber may either be incorporated into the various layers of the garment or shoe as a functional layer. Nanofibers could be utilized for just a single performance layer or the entire garment or a shoe utilizing a multiple layer nanofiber construction of various materials. Multiple fiber sizes for various gradients generating different points of performance. Various layers may be formed from different base polymers including, but not limited to PET, TPU, PA 6, PU, PTFE, and PVDF.

Clothing may be formed using fibers made from a melt or solution based composition. The fibers may be deposited on a substrate or deposited directly on a belt for later removal as a standalone web. In one embodiment, deposited fibers may form a nanofiber mat of between 0.5 and 100 grams per square meter in weight. The formed mat may either be laminated in between two protective layers of material (using commercially available lamination methods including melt urethanes or glues) and will act as the breathable moisture barrier for the garment material composite. Alternatively, the mat may be laminated to one layer of protective material (a backer) to also form a breathable moisture barrier but in this case the nanofiber layer would form one of the outward facing sides of the garment material composite. In another embodiment, the mat may be directly laid onto the protective material with no lamination required. Any of the above materials may be assembled into a suitable garment (coat, pants, shirts, etc.) using current standard cut and sew technologies.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be under stood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A microfiber and/or nanofiber coating system comprising:
a fiber producing device comprising a body, the body comprising a plurality of openings, wherein the body is configured to receive material to be produced into a fiber;
a driver, coupled to the body, the driver capable of rotating the body;
a deposition system that directs fibers produced by the fiber producing device toward an object disposed below the fiber producing device during use; and a support for an object to be coated during use, wherein the support allows motion of the object with respect to the fibers produced by the deposition system such that at least a portion of at least one of the exterior surfaces of the object can be positioned in fibers produced by the fiber producing device and directed by the deposition system; wherein, during use, rotation of the body causes material in the body to be ejected through one or more openings to produce microfibers and/or nanofibers that are at least partially transferred to the object using the deposition system and the support.

2. The system of claim 1, wherein the support comprises a support bracket and a motor coupled to the support bracket, wherein the motor is remotely operable, and wherein the motor moves the support bracket to alter the exterior surface of the object which is coated by the produced fibers.

3. The system of claim 1, wherein the support comprises a support bracket, a tilt motor coupled to the support bracket, and a rotation motor coupled to the support bracket, wherein each motor is independently operable, and wherein the tilt motor moves support bracket to tilt the object along a single axis of rotation, and wherein the rotation motor rotates the object to alter the axis of rotation of the object with respect to the tilt motor.

4. The system of claim 1, wherein the support comprises a support bracket, a rotation bracket, and a rotation motor, wherein the motor is coupled to the support bracket and the object to rotate the object about an axis of rotation, and wherein the rotation bracket is coupled to the support bracket to rotate the support bracket about an axis offset from a longitudinal axis of the support bracket.

5. The system of claim 1, wherein the deposition system comprises an electrostatic generator coupled to the object such that the object is given an opposite charge to a charge of the fibers produced by the fiber producing device such the produced fibers are drawn toward the substrate due to an electrostatic attraction to the electrostatic plate.

6. The system of claim 1, wherein the deposition system comprises a gas producing device configured to produce a gas flow that directs fibers formed by the fiber producing device toward the substrate.

7. The system of claim 1, further comprising a fiber recycling system coupled to the
deposition system, wherein fibers that are not deposited onto the object during use are collected by the fiber recycling system and returned to the deposition system.

8. The system of claim 1 further comprising a transfer system, wherein the transfer system moves one or more objects through the deposition system

9. A method of coating an object, comprising:
placing the object in a microfiber and/or nanofiber coating system as claimed in any one of claims 1-8; and rotating the fiber producing device about a spin axis such that rotation of the fiber producing device causes at least a portion of a composition disposed in the fiber producing device to be ejected through the one or more of the openings and form fibers as the ejected composition solidifies and coating at least a portion of the object with at least a portion of the produced microfibers and/or nanofibers.

10. The method of claim 9, wherein the object is in the shape of a foot, a hand, a head, a torso, or a waist with one or two legs joined to the waist,

11. The method of claim 9, wherein the composition comprises one or more polymers, wherein the one or more polymers are selected from the group consisting of: polyolefins, polyimides, polyamides and fluoropolymers.

12. The method of claim 9, wherein the composition comprises one or more polymers, wherein the one or more polymers are selected from the group consisting of: polytetrafluoroethylene (PTFE); thermoplastic polyurethane (TPU) polyurethane (PU), cellulose acetate (CA), polyvinylidene difluoride (PVDF), polyamide 6 (PA6), polyamide 6,6 (PA66), polyethylene terephthalate (PET), perfluoroalkoxy alkanes (PFA), polypropene (PP), polylactic acid (PLA), polycaprolactone (PCL), polyphenylene sulfide (PPS), polyacrylonitrile (PAN).

13. The method of claim 11, wherein the composition comprises one or more additives which: increase the hydrophobicity of the fibers; increase the alcohol resistance of the fibers increase the chemical resistance of the fibers, or increase the strength of the fibers.

14. The method of claim 9, wherein the fiber size is between 100 nm and 20 microns.

15. The method of claim 9, further comprising applying a surface treatment to the fiber coated object to: increase the increase the hydrophobicity of the fibers increase the alcohol resistance of the fibers; increase the chemical resistance of the fibers, or increase the strength of the fibers hydrophobicity.

16. A method of making a clothing item, comprising:
placing an object in a microfiber and/or nanofiber coating system as claimed in any one of claims 1-8, wherein the object is in the shape of a portion of a human body; and rotating the fiber producing device about a spin axis such that rotation of the fiber producing device causes at least a portion of a composition disposed in the fiber producing device to be ejected through the one or more of the openings and form fibers as the ejected composition solidifies; coating at least a portion of the object with at least a portion of the produced microfibers and/or nanofibers; incorporating the fiber coating into a clothing article or shoe.

17. The method of claim 16, wherein the fiber coating comprises multiple layers of different materials.
